(19) United States
(12) Patent Application Publication
(10) Pub. No.: US 2026/0218772 A1
(43) Pub. Date: Jul. 30, 2026

(54) PROGRESSIVE END-STOP CONTROL VALVES FOR VIBRATION DAMPERS

(71) Applicants: ThyssenKrupp Bilstein of America Inc., Hamilton, OH (US); thyssenkrupp AG, Essen (DE)

(72) Inventors: Camden IVES, Cincinnati, OH (US); Jayson MOORE, Cincinnati, OH (US); Eric SOROSIAK, Liberty Township, OH (US)

(73) Assignees: ThyssenKrupp Bilstein of America Inc., Hamilton, OH (US); thyssenkrupp AG, Essen (DE)

(21) Appl. No.: 19/040,106

(22) Filed: Jan. 29, 2025

(51) Int. Cl. F16F 9/49; B60G 13/08; B60G 17/08; F16F 9/19; F16F 9/32; F16F 9/348

(52) U.S. Cl. CPC F16F 9/49; F16F 9/19; F16F 9/3214; F16F 9/348; B60G 13/08; B60G 17/08; B60G 2202/24; B60G 2204/62; B60G 2206/41; B60G 2500/112; B60G 2600/20; B60G 2800/162; B60G 2800/916; F16F 2222/12; F16F 2228/066; F16F 2230/183; F16F 2230/36; F16F 2230/42

(57) ABSTRACT

An end-stop control valve includes a piston assembly, a valve disc stack-up, and a catch piston, wherein the piston assembly is configured such that, when a contact surface of the piston assembly contacts a contact surface of the catch piston such that hydraulic fluid cannot flow around the piston assembly during an end-of-stroke damping event, the end-stop control valve is configured to operate, first, such that hydraulic fluid flows through the piston assembly and bypasses the valve disc stack-up, and second, such that hydraulic fluid flows through the piston assembly and deflects the valve disc stack-up.

### FIELD

The present disclosure generally relates to vibration dampers, including end-stop control valves that are configured to provide a progressive amount of damping force in vibration dampers used in vehicles.

### BACKGROUND

Vibration dampers, such as hydraulic vibration dampers, are used in vehicles to dissipate vibration energy caused by the vehicle travelling over uneven road surfaces. Generally, vibration dampers can include a damper tube and a working piston guided in the damper tube along a longitudinal axis. A piston rod leading out of the damper tube can be arranged on the working piston and, by way of the piston rod, the working piston can be displaced in the damper tube. The piston rod is caused to traverse within the damper tube in an extension direction (that is, outward relative to the damper tube, referred to herein as “rebound”) and a compression or retraction direction (that is, inward relative to the damper tube, referred to herein as “jounce”) during a damping event. In general, the piston rod can be limited in the extension direction at a fully extended position and in the compression, jounce, or retraction direction at a fully compressed position.

Such vibration dampers or “shock absorbers” are used in automotive, recreational, and industrial vehicles to assist the vehicle in adapting to different driving conditions due to irregularities in the road such as bumps, potholes, and other road surface anomalies. Vibration dampers are also used to assist a vehicle in traveling over more extreme conditions such as off-road driving. In certain conditions, such as high-speed driving or off-road driving, for instance, the irregularities can be severe and may cause a standard vibration damper to bottom out, that is, abruptly reach its maximum compression or maximum rebound position and produce a jarring impact. When such a maximum compression or maximum rebound position occurs in the vibration damper, a sudden jolt can cause the respective wheel to lift off the ground. Hence, this jarring impact can also lead to a loss of traction.

In examples, it can be desirable to mitigate the forces seen on the vibration damper before reaching either the fully extended position or the fully compressed position, such as by increasing damping forces prior to the damper bottoming out. For example, at full compression, undesirable noise, vibration and harshness (NVH) characteristics, as well as undesirable effects to performance and comfort, can result due to any abrupt contact of features within the vibration damper at, or near, full compression.

To address such problems, vibration dampers with controlled compression stage end position damping were developed. Such a vibration damper is known from WIPO Patent Publication No. WO 2015/105791 A1, where the vibration damper includes a first piston for controlling the rebound stage and the compression stage and a piston rod with a valve assembly. The first piston is arranged on the piston rod. If the valve assembly on the piston rod enters an end region of the damper tube in compression, the valve assembly engages a second piston to cause an increase in damping force. The second piston can be moved even farther in compression towards a third piston, which interacts with the second piston and causes a further increase in damping force. Vibration dampers like that disclosed in WIPO Patent Publication No. WO 2015/105791 A1 are oftentimes referred to as jounce control vibration dampers. More recent efforts, such as those disclosed in German Utility Model Application No. DE 202019101886 U1, for example, have incorporated such “end-stop” or “auxiliary” pistons at both ends of the vibration damper to either prevent or at least ease into a state where the vibration damper is at a maximum compression position or a maximum rebound position.

However, the increase in damping force associated with such known auxiliary pistons resembles a step function into a peak force output, with a large increase in damping force being supplied as the auxiliary piston is engaged. Although this large increase in damping force is not nearly as harsh as the forces present at a maximum compression or maximum rebound position in a vibration damper without any form of jounce or rebound control, the jump in damping force can potentially cause a large, rapid change in acceleration; undesirable noise, vibration, and harshness (NVH) effects within the vehicle; and a change in performance.

### SUMMARY

An end-stop control valve may be summarized as comprising: a piston assembly configured to move longitudinally within a damper tube; a valve disc stack-up; and a catch piston configured to engage the piston assembly during an end-of-stroke damping event, the catch piston configured to be disposed on an inner wall of the damper tube in a longitudinally movable manner; wherein a radially outermost portion of the piston assembly is configured to be spaced radially apart from the inner wall of the damper tube such that hydraulic fluid can flow between the piston assembly and the inner wall of the damper tube outside of the end-of-stroke damping event and when the piston assembly is not engaged with the catch piston; wherein the piston assembly is configured such that, when a contact surface of the piston assembly contacts a contact surface of the catch piston such that hydraulic fluid cannot flow around the piston assembly during the end-of-stroke damping event, the end-stop control valve is configured to operate, first, such that hydraulic fluid flows through the piston assembly and bypasses the valve disc stack-up, and second, such that hydraulic fluid flows through the piston assembly and deflects the valve disc stack-up.

The piston assembly may be configured such that a size of an aperture through which hydraulic fluid bypasses the valve disc stack-up decreases during the end-of-stroke damping event such that the piston assembly progressively transitions from hydraulic fluid bypassing the valve disc stack-up to hydraulic fluid deflecting the valve disc stack-up. The piston assembly may include an annular void and the rate at which the aperture through which hydraulic fluid bypasses the valve disc stack-up decreases during the end-of-stroke damping event and the rate at which the piston assembly progressively transitions from hydraulic fluid bypassing the valve disc stack-up to hydraulic fluid deflecting the valve disc stack-up are dependent upon a rate at which hydraulic fluid escapes from the annular void.

The rate at which hydraulic fluid escapes from the annular void may depend upon a size of an orifice through which hydraulic fluid can flow out of the annular void. The piston assembly may include a piston insert that is fixed relative to the valve disc stack-up and a piston configured to travel longitudinally relative to the valve disc stack-up, wherein the orifice is formed between a linear inner surface of the piston and an outer surface of the piston insert that is curved such that, as the piston moves toward the piston insert, the size of the orifice decreases, resistance to flow of hydraulic fluid out of the annular void increases, and the speed at which hydraulic fluid flows out of the annular void slows.

The piston assembly may be configured such that, as hydraulic fluid flows through the piston assembly, a preload is applied to the valve disc stack-up at a rate dependent upon a rate at which hydraulic fluid flows out of an annular void within the piston assembly. The piston assembly may be configured such that no preload is applied to the valve disc stack-up. The piston assembly may include a piston insert that is fixed relative to the valve disc stack-up and a piston configured to travel longitudinally relative to the valve disc stack-up. The piston assembly may include a passage by which hydraulic fluid can flow through the piston assembly, wherein the passage extends radially outward and longitudinally through the piston insert.

The passage may extend longitudinally to an interface between the valve disc stack-up and a seat of the piston insert. When the piston assembly is not engaged with the catch piston, the radially-extending portion of the passage may be open at a radially-outermost side surface of the piston assembly, forming a bypass opening through which hydraulic fluid can flow through the piston assembly without encountering the valve disc stack-up. During the end-of-stroke damping event, the piston may be configured to travel longitudinally relative to the piston insert such that the radially-extending portion of the passage is closed at the radially-outermost side surface of the piston assembly by an inner surface of the piston, closing the bypass opening such that hydraulic fluid cannot flow through the piston assembly without encountering the valve disc stack-up.

The piston insert may be a first piston insert, the piston assembly may include a second piston insert, and the piston assembly may include a passage by which hydraulic fluid can flow through the piston assembly, wherein the passage extends longitudinally between a piston rod and the first piston insert, radially outward between the first piston insert and the second piston insert, and longitudinally through the second piston insert.

A vibration damper may be summarized as comprising: a damper tube that extends along a longitudinal axis and includes an inner wall; a piston rod that extends into the damper tube and is configured to move longitudinally within the damper tube; a main piston secured on the piston rod that separates the damper tube into a first working chamber and a second working chamber, wherein the main piston includes a first valve disc stack-up; an end-stop control valve disposed on a longitudinal side of the main piston, the end-stop control valve including: a second piston configured to move longitudinally within the damper tube; a second valve disc stack-up; and a catch piston configured to engage the second piston during an end-of-stroke damping event, the catch piston disposed on the inner wall of the damper tube in a longitudinally movable manner; wherein a radially outermost portion of the second piston is spaced radially apart from the inner wall of the damper tube such that hydraulic fluid can flow between the second piston and the inner wall of the damper tube outside of the end-of-stroke damping event and when the second piston is not engaged with the catch piston; wherein the second piston is configured such that, when a contact surface of the second piston contacts a contact surface of the catch piston such that hydraulic fluid cannot flow around the second piston during the end-of-stroke damping event, the end-stop control valve is configured to operate, first, such that hydraulic fluid flows through the second piston and bypasses the second valve disc stack-up, and second, such that hydraulic fluid flows through the second piston and deflects the second valve disc stack-up.

The end-stop control valve may be a jounce cutoff end-stop control valve. The end-stop control valve may be a rebound cutoff end-stop control valve. The end-stop control valve may be a first end-stop control valve, the catch piston may be a first catch piston, and the vibration damper may further comprise a second end-stop control valve, the second end-stop control valve including: a third piston configured to move longitudinally within the damper tube; a third valve disc stack-up; and a second catch piston configured to engage the third piston during an end-of-stroke damping event, the second catch piston disposed on the inner wall of the damper tube in a longitudinally movable manner; wherein a radially outermost portion of the third piston is spaced radially apart from the inner wall of the damper tube such that hydraulic fluid can flow between the third piston and the inner wall of the damper tube outside of the end-of-stroke damping event and when the third piston is not engaged with the second catch piston; wherein the third piston is configured such that, when a contact surface of the third piston contacts a contact surface of the second catch piston such that hydraulic fluid cannot flow around the third piston during the end-of-stroke damping event, the second end-stop control valve is configured to operate, first, such that hydraulic fluid flows through the third piston and bypasses the third valve disc stack-up, and second, such that hydraulic fluid flows through the third piston and deflects the third valve disc stack-up.

Further areas of applicability of the teachings of the present disclosure will become apparent from the detailed description, claims, and the drawings, wherein like reference numerals refer to like features throughout the several views of the drawings. It should be understood that the detailed description, including disclosed embodiments and drawings referenced therein, are intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 illustrates a cross-sectional view of a first hydraulic vibration damper system.

FIG. 2 illustrates a cut-away view of the first hydraulic vibration damper system of FIG. 1.

FIG. 3 illustrates a cross-sectional view of portions of the first hydraulic vibration damper system of FIGS. 1 and 2 in a compressed configuration relative to that illustrated in FIGS. 1 and 2, in which a secondary piston is disengaged.

FIG. 4 illustrates a slice view of portions of the first hydraulic vibration damper system of FIGS. 1 and 2 in a compressed configuration corresponding to that of FIG. 3.

FIG. 5 illustrates a cross-sectional view of portions of the first hydraulic vibration damper system of FIGS. 1 and 2 in a compressed configuration relative to that illustrated in FIGS. 1-4, in which a secondary piston is initially engaged and in which a jounce cutoff valve piston assembly provides a relatively low end-stop resistance.

FIG. 6 illustrates a slice view of portions of the first hydraulic vibration damper system of FIGS. 1 and 2 in a compressed configuration corresponding to that of FIG. 5.

FIG. 7 illustrates a cross-sectional view of portions of the first hydraulic vibration damper system of FIGS. 1 and 2 in a compressed configuration relative to that illustrated in FIGS. 1-6, in which a secondary piston is partially engaged and in which a jounce cutoff valve piston assembly provides an intermediate end-stop resistance.

FIG. 8 illustrates a slice view of portions of the first hydraulic vibration damper system of FIGS. 1 and 2 in a compressed configuration corresponding to that of FIG. 7.

FIG. 9 illustrates a cross-sectional view of portions of the first hydraulic vibration damper system of FIGS. 1 and 2 in a compressed configuration relative to that illustrated in FIGS. 1-8, in which a secondary piston is fully engaged and in which a jounce cutoff valve piston assembly provides a relatively high end-stop resistance.

FIG. 10 illustrates a slice view of portions of the first hydraulic vibration damper system of FIGS. 1 and 2 in a compressed configuration corresponding to that of FIG. 9.

FIG. 11 illustrates a larger view of a portion of a piston rod and of a working piston assembly mounted thereon of the first hydraulic vibration damper system of FIGS. 1 and 2.

FIG. 12 illustrates a cut-away view of the portion of the piston rod and the working piston assembly of FIG. 11.

FIG. 13 illustrates a cross-sectional view of the portion of the piston rod and the working piston assembly of FIG. 11.

FIG. 14 illustrates a cross-sectional view of a second hydraulic vibration damper system.

FIG. 15 illustrates a cut-away view of the second hydraulic vibration damper system of FIG. 14.

FIG. 16 illustrates a cross-sectional view of portions of the second hydraulic vibration damper system of FIGS. 14 and 15 in a compressed configuration relative to that illustrated in FIGS. 14 and 15, in which a secondary piston is disengaged.

FIG. 17 illustrates a slice view of portions of the second hydraulic vibration damper system of FIGS. 14 and 15 in a compressed configuration corresponding to that of FIG. 16.

FIG. 18 illustrates a cross-sectional view of portions of the second hydraulic vibration damper system of FIGS. 14 and 15 in a compressed configuration relative to that illustrated in FIGS. 14-17, in which a secondary piston is initially engaged and in which a jounce cutoff valve piston assembly provides a relatively low end-stop resistance.

FIG. 19 illustrates a slice view of portions of the second hydraulic vibration damper system of FIGS. 14 and 15 in a compressed configuration corresponding to that of FIG. 18.

FIG. 20 illustrates a cross-sectional view of portions of the second hydraulic vibration damper system of FIGS. 14 and 15 in a compressed configuration relative to that illustrated in FIGS. 14-19, in which a secondary piston is partially engaged and in which a jounce cutoff valve piston assembly provides an intermediate end-stop resistance.

FIG. 21 illustrates a slice view of portions of the second hydraulic vibration damper system of FIGS. 14 and 15 in a compressed configuration corresponding to that of FIG. 20.

FIG. 22 illustrates a cross-sectional view of portions of the second hydraulic vibration damper system of FIGS. 14 and 15 in a compressed configuration relative to that illustrated in FIGS. 14-21, in which a secondary piston is fully engaged and in which a jounce cutoff valve piston assembly provides a relatively high end-stop resistance.

FIG. 23 illustrates a slice view of portions of the second hydraulic vibration damper system of FIGS. 14 and 15 in a compressed configuration corresponding to that of FIG. 22.

FIG. 24 illustrates a larger view of a portion of a piston rod and of a working piston assembly mounted thereon of the second hydraulic vibration damper system of FIGS. 14 and 15.

FIG. 25 illustrates a cut-away view of the portion of the piston rod and the working piston assembly of FIG. 24.

FIG. 26 illustrates a cross-sectional view of the portion of the piston rod and the working piston assembly of FIG. 24.

### DETAILED DESCRIPTION

In hydraulic vibration dampers, the piston rod can be limited in the extension direction at a fully extended position and in the compression, jounce, or retraction direction at a fully retracted or fully compressed position. In examples, it can be desirable to increase the forces seen on the vibration damper and the damping effect provided by the damper before reaching the fully compressed position and/or the fully extended position, such as to reduce an amount of energy that goes into and is dissipated in a hard stop impact and thereby reduce or avoid harsh impacts experienced within the vibration damper at, or near, full compression and/or full extension. Furthermore, it can be advantageous to configure hydraulic dampers to provide smooth transitions between different damping regimes.

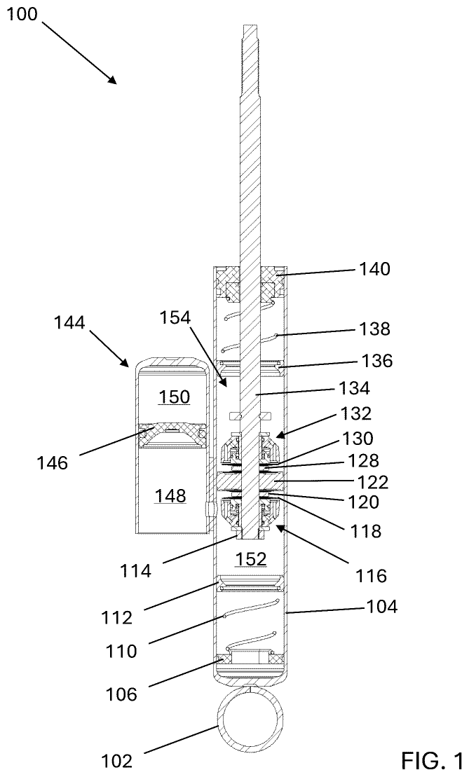

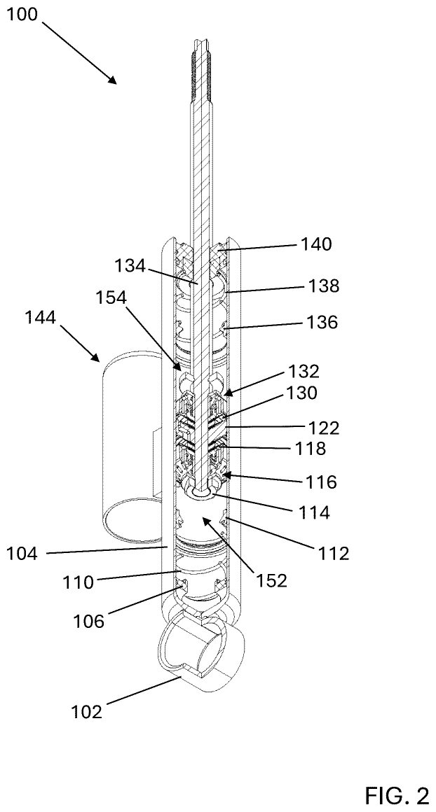

An example vibration damper 100 is shown in FIGS. 1 and 2, with FIG. 1 showing a cross-sectional view of the vibration damper 100 and FIG. 2 showing a cutaway view of the vibration damper 100. In general, the vibration damper 100 in this example includes an eye ring 102, a damper tube 104, a jounce cutoff (JCO) crimp ring 106 with a spring retention means, a JCO spring 110, a JCO catch piston 112, a piston rod assembly fastener 114, a JCO valve piston assembly 116, a JCO valve disc stack-up 118 of the JCO valve piston assembly 116, a first brake washer 120, a main piston 122 with valve discs, a second brake washer 128, a rebound cutoff (RCO) valve disc stack-up 130, an RCO valve piston assembly 132, a piston rod 134, an RCO catch piston 136, an RCO spring 138, a sealing package 140 with a spring retention means, and a reservoir 144 with a dividing piston 146 that separates the reservoir 144 into a first volume 148 and a second volume 150.

The main piston 122, the JCO valve piston assembly 116, and the RCO valve piston assembly 132, among other components, may be positioned along the piston rod 134 so as to be movable with the piston rod 134 in the damper tube 104 along a longitudinal axis L of the vibration damper 100. The main piston 122 separates an interior of the damper tube 104 into a first working chamber 152 and a second working chamber 154, with the JCO valve piston assembly 116 being disposed in the first working chamber 152 and the RCO valve piston assembly 132 being disposed in the second working chamber 154. The working chambers 152, 154 are fluidly connected to one another by the main piston 122 depending on a direction of movement of the piston rod 134. For this purpose, the main piston 122 includes the valve discs, which govern flow of hydraulic fluid during, respectively, a compression stage and a rebound stage of the vibration damper 100. During operation, the working chambers 152, 154 are filled with hydraulic fluid or damper oil. To increase the damping force in the end regions of the damper tube 104, the JCO valve piston assembly 116 and the RCO valve piston assembly 132 engage, respectively, with the associated catch pistons 112, 136, which will be discussed in more detail further below.

The vibration damper 100 in this example also includes the reservoir 144 in which the dividing piston 146 for separating a damper gas from hydraulic fluid is movably arranged. In other words, the dividing piston 146 separates the first volume 148, which contains hydraulic fluid, from the second volume 150, which contains gas. The first volume 148 is fluidically connected to the first working chamber 152 of the damper tube 104 via a through-opening. During operation, the first volume 148 in the reservoir 144, much like the first and second working chambers 152, 154, is filled with hydraulic fluid. The second volume 150 is filled with gas, which charges, pressurizes, or otherwise biases the dividing piston 146 against the hydraulic fluid.

As can be seen in FIGS. 1 and 2, the main piston 122 is disposed between the JCO valve piston assembly 116 and the RCO valve piston assembly 132 on the piston rod 134. More specifically, the JCO valve piston assembly 116, the JCO valve disc stack-up 118 thereof, the first brake washer 120, the main piston 122, the second brake washer 128, the RCO valve piston assembly 132, and the RCO valve disc stack-up 130 thereof may be securely fastened along the piston rod 134 between the piston rod assembly fastener 114 and a shoulder, for example, of the piston rod 134. Hence, in the case of a compression stage or a rebound stage, the main piston 122, the JCO valve piston assembly 116, and the RCO valve piston assembly 132 move longitudinally with the piston rod 134. In many cases, the JCO valve piston assembly 116 and the RCO valve piston assembly 132 are mirror images of one another. In other cases, though, the JCO valve piston assembly 116 may be different (e.g., in terms of piston shape and/or valve disc stack-up) than the RCO valve piston assembly 132.

A radial gap is provided between the JCO valve piston assembly 116 and an inner wall of the damper tube 104. Likewise, a radial gap is provided between the RCO valve piston assembly 132 and the inner wall of the damper tube 104. Consequently, so long as neither the JCO catch piston 112 nor the RCO catch piston 136 is engaged, hydraulic fluid can flow around the JCO valve piston assembly 116 and around the RCO valve piston assembly 132 during operation of the vibration damper 100.

In some examples, vibration dampers may further include a spacer element that is disposed between a JCO valve piston assembly and a main piston. The spacer element may be pushed onto the piston rod and may, depending on the configuration, prevent the main piston from passing over a through-opening that leads to a reservoir. The spacer element may have a smaller radial extent than the valve piston assemblies. In other words, the spacer element may be configured to be smaller transversely to the longitudinal direction of the vibration damper than the valve piston assemblies. Further, the spacer element can be cylindrical. It should also be understood that the spacer element can have an angular cross section. In other words, the spacer element can also be cuboid.

With continued reference to the example vibration damper 100 shown in FIGS. 1 and 2, the JCO valve piston assembly 116 faces a first end of the damper tube 104. The first end of the damper tube 104 corresponds to an end of the damper tube 104 that faces away from the piston rod 134. The RCO valve piston assembly 132 faces a second end of the damper tube 104. The second end of the damper tube 104 corresponds to an end of the damper tube 104 on the piston rod side. The sealing package 140 is arranged in the damper tube 104 at the second end of the damper tube 104. In some cases, the sealing package 140 may be positively connected to the damper tube 104. The sealing package 140 may be connected to the damper tube 104 by crimping. The piston rod 134 is guided in the sealing package 140 so that the piston rod 134 can move longitudinally through and with respect to the sealing package 140.

In the first working chamber 152 of the damper tube 104, the JCO catch piston 112 is disposed towards the first end 162. The JCO catch piston 112 is movable longitudinally within the damper tube 104, although the JCO spring 110 restores the JCO catch piston 112 to the position shown in FIG. 1 when the JCO catch piston 112 is not engaged. Similarly, in the second working chamber 154 of the damper tube 104, the RCO catch piston 136 is disposed towards the second end 164. The RCO catch piston 136 is movable longitudinally within the damper tube 104, although the RCO spring 138 restores the RCO catch piston 136 to the position shown in FIG. 1 when the RCO catch piston 136 is not engaged. Further, the catch pistons 112, 136 may be annular and may be arranged in a sealing manner with respect to the inner wall 114 of the damper tube 104.

The catch pistons 112, 136 each have a main opening that extends longitudinally and is configured as a longitudinally-extending through opening. Each main opening has a sealing area that is configured to mate with a respective portion of the valve piston assemblies 116, 132. In particular, in the case of end-of-travel damping in compression a JCO piston of the JCO valve piston assembly 116 engages and mates with the sealing area of the JCO catch piston 112 to form a seal. In the case of end-of-travel damping in rebound, an RCO piston of the RCO valve piston assembly 132 engages and mates with the sealing area of the RCO catch piston 136 to form a seal. As can be seen especially in FIG. 1, the JCO piston and the RCO piston each have an outer contour that complements the sealing areas of the main openings.

Also arranged at the first end of the damper tube 104 is the JCO crimp ring 106, which may be positively connected to the damper tube 104 by crimping. The JCO crimp ring 106 and/or the sealing package 140 can also be pressed into the damper tube 104. In other words, the JCO crimp ring 106 and/or the sealing package 140 can be connected to the damper tube 104 in a non-positive manner. The JCO crimp ring 106 and/or the sealing package 140 can additionally or alternatively be integrally connected to the damper tube 106 by welding. In general, it is also conceivable for the JCO crimp ring 106 and/or the sealing package 140 to be connected to the damper tube 104 by still other techniques, including combinations of the connection types mentioned above.

The JCO crimp ring 106 and the sealing package 140 have spring retention means on which the JCO spring 110 and the RCO spring 138 are, respectively, fixedly arranged. The JCO crimp ring 106 and the sealing package 140 are arranged with the spring retention means in the longitudinal direction opposite the respective catch piston 112, 136. The spring retention means serve as an abutment on which the springs 110, 138 are supported. The springs 110, 138 hold the catch pistons 112, 136 in respective longitudinal starting positions when the catch pistons 112, 136 are not engaged. In particular, after end-of-stroke cushioning, the JCO spring 110 guides the JCO catch piston 112 in a compression stage after longitudinal displacement or movement by the JCO valve piston assembly 116 back into the original, longitudinal starting position. Likewise, after end-of-stroke cushioning, the RCO spring 138 guides the RCO catch piston 136 in a rebound stage after longitudinal displacement or movement by the RCO valve piston assembly 132 back into the original, longitudinal starting position. As explained above, the springs 110, 138 serve as return springs. Furthermore, the JCO crimp ring 106 may also include an opening for receiving at least part of the piston rod assembly fastener 114 and the piston rod 134 in a full compression stroke.

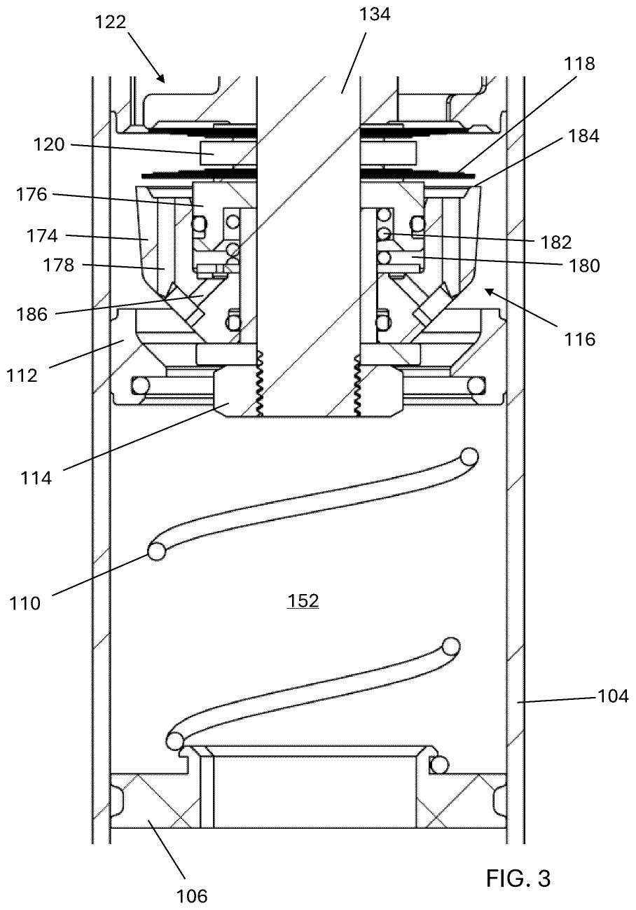

The general operation of the vibration damper 100 and the flow of hydraulic fluid therein will now be explained with reference to FIGS. 3-10, particularly with respect to the relation between the main piston 122 and the valve piston assemblies 116, 132. Although FIGS. 3-10 concern a compression stroke and thus primarily JCO-related components, those having ordinary skill in the art will understand the applicability of this teaching to a rebound stroke and RCO-related components as well.

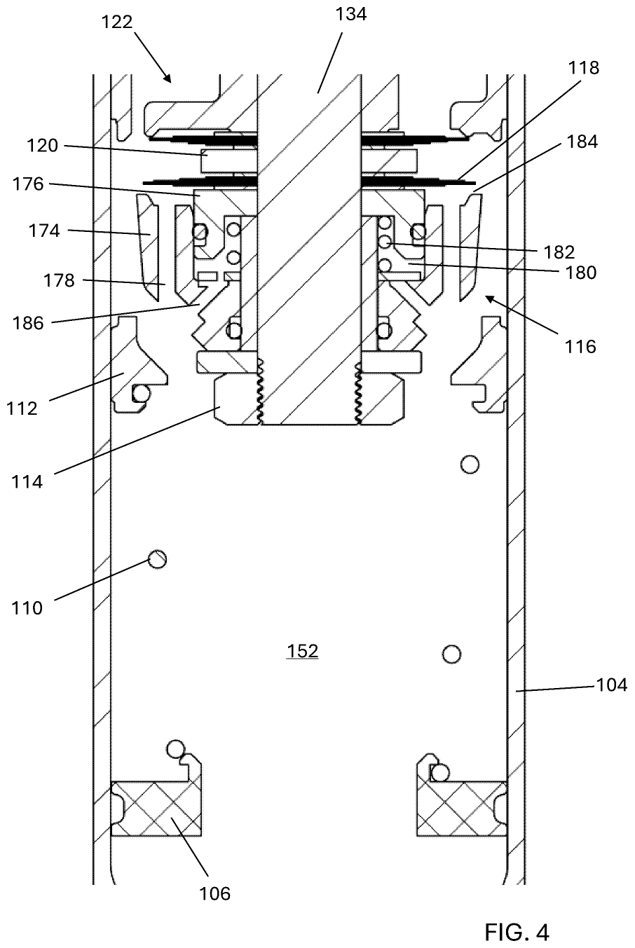

End-of-stroke damping is utilized in compression and in rebound where large displacement of the piston rod 134 occurs. To this end, FIGS. 3 and 4 show the piston rod 134 moving in a compression stroke towards the first end 162 of the damper tube 104. Due to the stroke movement of the main piston 122 and due to the JCO valve piston assembly being spaced apart from the JCO catch piston 112, the hydraulic fluid flows from the first working chamber 152, around the JCO valve piston assembly 116, through the main piston 122, deflecting the valve discs thereof, and into the second working chamber 154. As the hydraulic fluid flows through the main piston 122, such flow is highly controlled such that viscosity, friction, and/or other effects provide resistance to movement of the piston rod 134 relative to the damper tube 104 and convert kinetic energy of the piston rod 134 into heat in the hydraulic fluid, which is then dissipated to the environment through the damper tube 104.

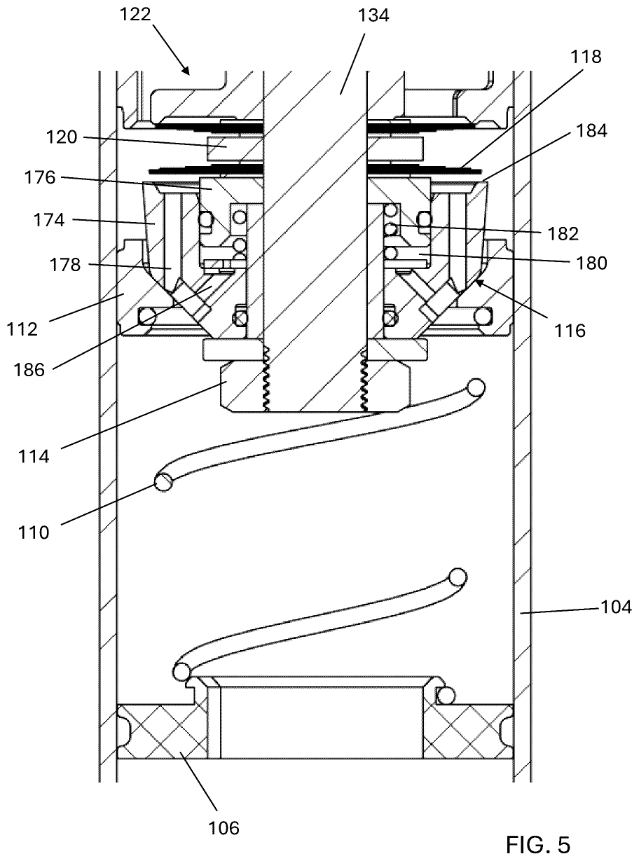

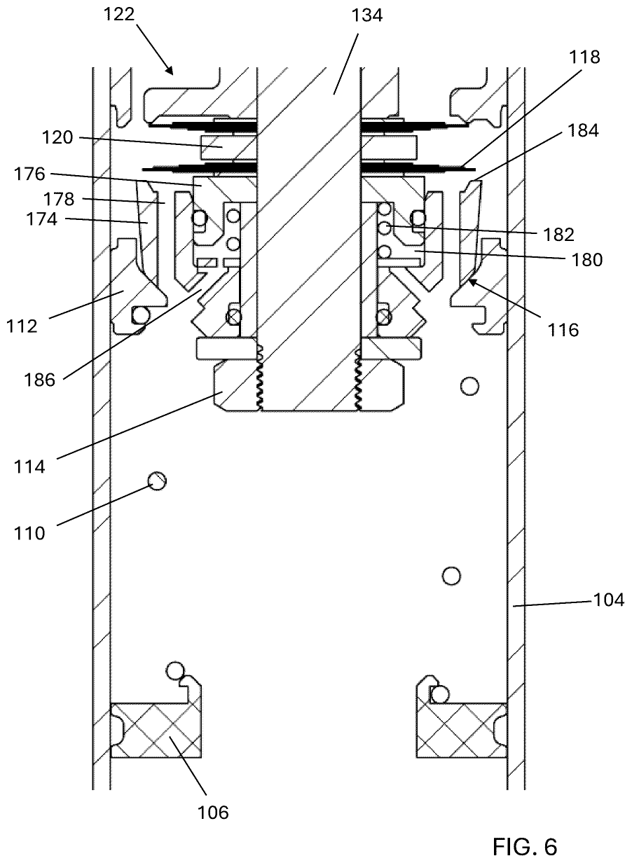

As shown in FIGS. 5 and 6, if the piston rod 134 is driven far enough into the damper tube 104, the JCO valve piston assembly 116, specifically, the JCO piston thereof, engages and mates with the JCO catch piston to form a seal. At this point, hydraulic fluid is sealed in a third working chamber, which in FIGS. 5 and 6 is below the JCO catch piston assembly 116. More details regarding flow through the JCO valve piston assembly 116 will be provided further below, but the hydraulic fluid passes from the third working chamber through the JCO valve piston assembly 116, deflecting the JCO valve disc stack-up 118 thereof, into the first working chamber 152, through the main piston 122, deflecting the valve discs thereof, and into the second working chamber 154.

As the hydraulic fluid flows through the JCO valve piston assembly 116, such flow is highly controlled such that viscosity, friction, and/or other effects provide resistance to movement of the piston rod 134 relative to the damper tube 104 and convert kinetic energy of the piston rod 134 into heat in the hydraulic fluid, which is then dissipated to the environment through the damper tube 104. Because the hydraulic fluid is passing through both the main piston 122 and the JCO valve piston assembly 116, the damping force provided by the deflection of the JCO valve disc stack-up 118 of the JCO valve piston assembly 116 is additive to the damping force provided by the deflection of the valve discs of the main piston 122.

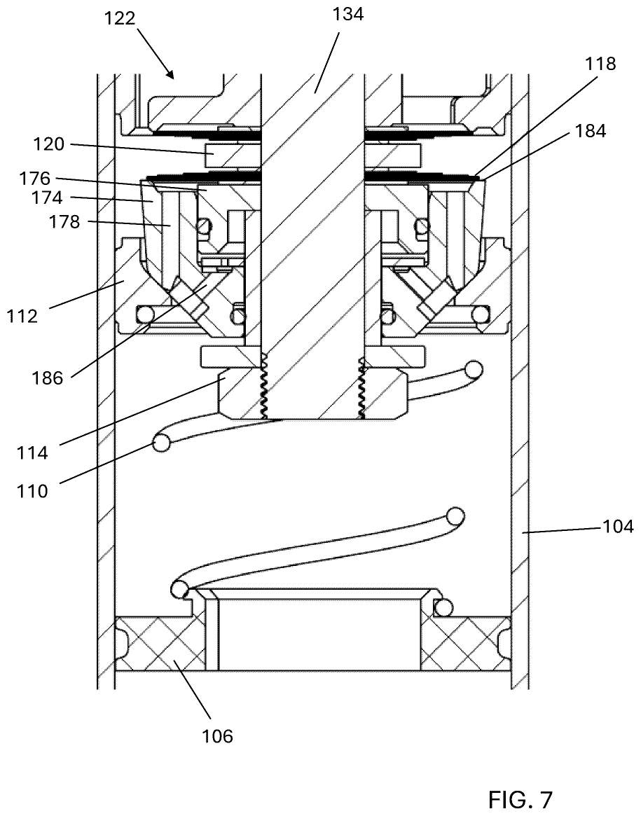

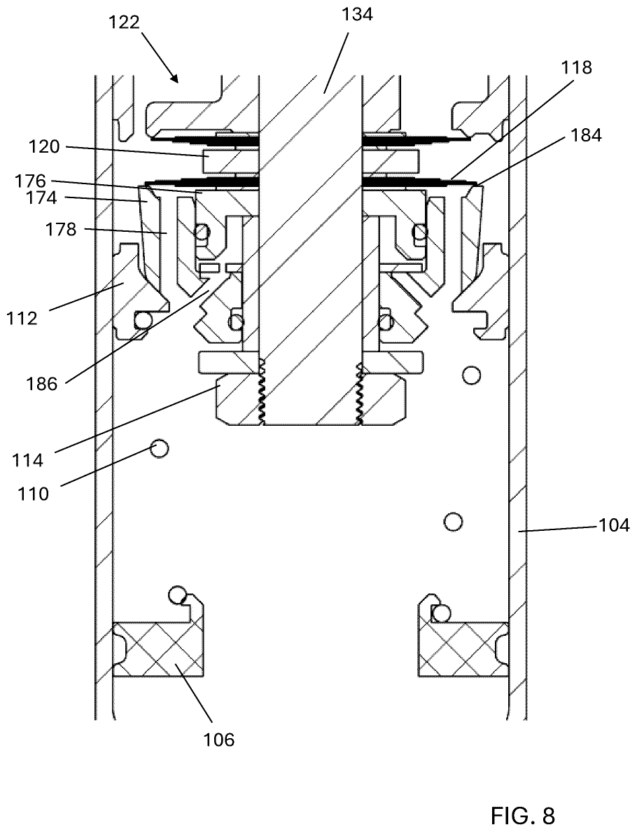

As reflected in FIGS. 7 and 8, as the compression stroke continues, the volume of the third working chamber becomes smaller as the JCO catch piston 112 and the JCO valve piston assembly 116 move closer to the first end of the damper tube 104. The JCO valve disc stack-up 118 deflects even more as the pressure of the hydraulic fluid in the third working chamber builds, thereby providing an increasing amount of damping force.

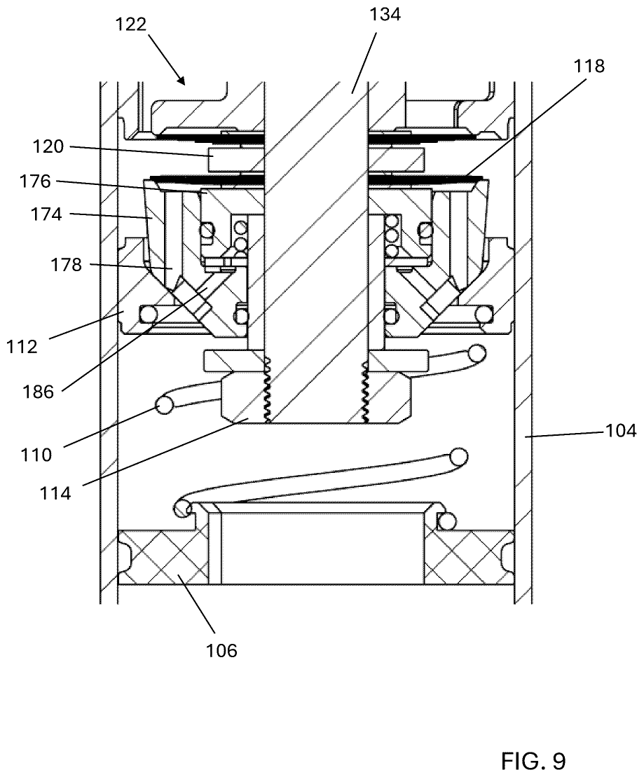

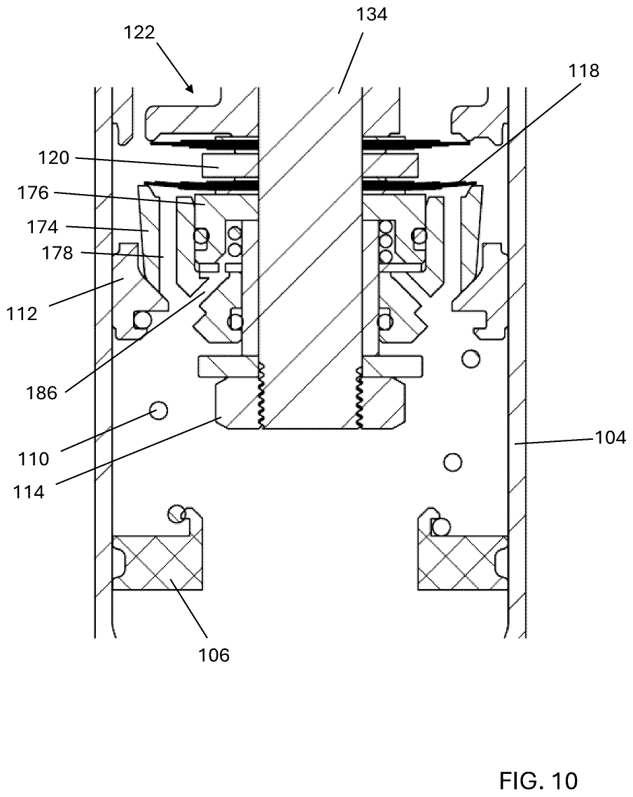

As reflected in FIGS. 9 and 10, as the compression stroke ends when the system bottoms-out, the volume of the third working chamber reaches its minimum.

Immediately following the end of the compression stroke, the JCO valve piston assembly 116 disengages from the JCO catch piston 112 as the piston rod 134, the JCO valve piston assembly 116, the main piston 122, and other components disposed along the piston rod 134 begin moving away from the first end of the damper tube 104. Consequently, hydraulic fluid flows from the second working chamber 154 through the main piston 122, deflecting the valve discs thereof, into the first working chamber 152 and around the JCO valve piston assembly 116. The third working chamber ceases to exist due to the separation of the JCO valve piston assembly 116 from the JCO catch piston 112. The JCO spring 110 then returns the JCO catch piston 112 to its longitudinal starting position.

One having ordinary skill in the art would understand how hydraulic fluid may flow similarly in a rebound stroke involving the RCO valve piston assembly 132 and the RCO catch piston 136.

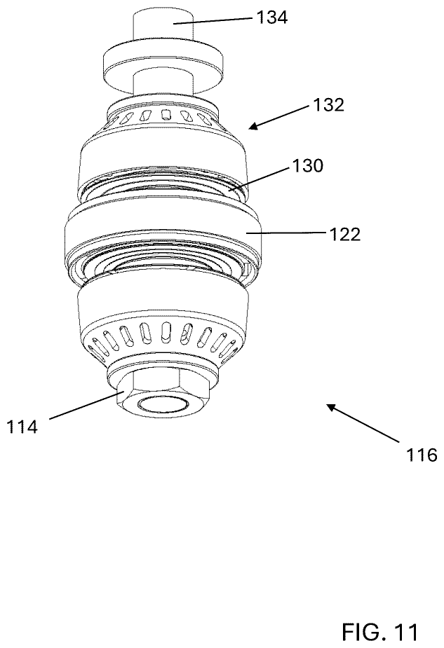

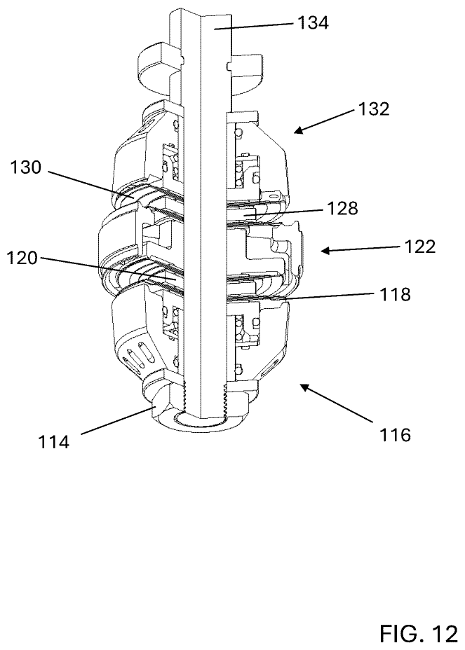

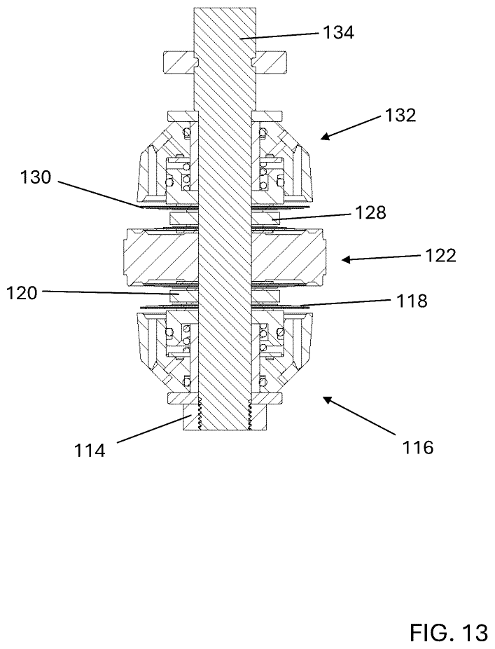

Turning now to FIGS. 11-13, a free or distal end of the piston rod 134 is shown in more detail, with FIG. 11 providing a perspective view, FIG. 12 providing a cutaway view, and FIG. 13 providing a cross-sectional view through the distal end. While more focus may be placed on the JCO valve piston assembly 116 here, those having ordinary skill in the art will appreciate how the teachings may apply with equal force to the RCO valve piston assembly 132.

Building upon the disclosure above, in some examples each valve piston assembly 116, 132 may generally include a respective piston (e.g., valve piston 174 illustrated in FIGS. 3-10) and a valve piston insert (e.g., valve piston insert 176 illustrated in FIGS. 3-10). Each piston may include passages (e.g., passage 178 illustrated in FIGS. 3-10) that extend longitudinally through the piston and through which hydraulic fluid can flow. In some cases, the passages may have circular cross-sections when viewed from a longitudinal perspective. In other cases, though, the passages may be elongated circumferentially. The valve piston inserts may be arranged radially inward relative to the pistons.

While the valve piston inserts, among other components, may be fixed longitudinally along the piston rod 134, the pistons may move longitudinally relative to the piston rod 134 and the respective valve piston inserts, as will be described in more detail below.

In some examples such as that shown in FIGS. 3-10, the valve piston insert 176 and the piston 174 may be sized and shaped so as to form an annular void 180 longitudinally and radially between the valve piston insert 176 and the piston 174. Wave spring(s) 182 may be inserted in the annular void 180. The wave spring 182 serves to longitudinally separate the piston 174 from the valve piston insert 176, and to return the piston 174 and valve piston insert 176 to their original positions relative to one another, after end-of-stroke damping events. The annular void 180 provides a reservoir of hydraulic fluid that is physically distinct from, and separated and isolated from, the first working chamber 152 except that it is hydraulically coupled to the first working chamber 152 by a passage 186.

The piston 174 may have a valve seat 184 that extends annularly around the piston rod 134 and is configured, at least selectively, to form a seal with the respective valve disc stack-up 118. The valve seat 184 may be chamfered or radiused. As one having ordinary skill in the art will appreciate, especially in light of the discussion below, such chamfers or radiuses accommodate preload of the valve disc stack-ups 118, 130; help form a better seal with the valve disc stack-ups 118, 130; facilitate better control over the flow of hydraulic fluid; and enable smooth deformation of the valve disc stack-ups 118, 130 during end-of-stroke damping.

Typically, at least with respect to conventional pistons, the term “preload” describes the position of the valve disc stack-up relative to the valve seat and hence the extent to which a valve disc stack-up is deformed (if any) in a steady state, prior to any damping movement. In the present disclosure, however, the preload of the valve piston assembly, specifically, of the valve disc stack-up, varies over at least part of the course of the end-of-stroke damping.

FIGS. 3 and 4 illustrate portions of the vibration damper 100 in a compressed configuration relative to that illustrated in FIGS. 1 and 2, but before the JCO piston assembly 116 engages the JCO catch piston 112. This configuration represents a first operational mode of the JCO piston assembly, that is, a disengaged mode. In this mode, hydraulic fluid can flow around the entirety of the JCO piston assembly 116, so the JCO piston assembly does not contribute in a significant way to the overall damping performance of the vibration damper 100. In this mode, the overall damping performance or the entirety of the damping performance of the vibration damper 100 is provided by the main piston 122.

FIGS. 5 and 6 illustrate portions of the vibration damper 100 in a compressed configuration relative to that illustrated in FIGS. 3 and 4, and in which the JCO piston assembly 116 initially engages the JCO catch piston 112, in which the volume of the annular void 180 is at its maximum, and in which the JCO piston assembly 116 provides a relatively low end-stop resistance. This configuration represents a transition from the first operational mode to a second operational mode of the JCO piston assembly 116, that is, a partially engaged mode. In this configuration, hydraulic fluid can no longer flow around the entirety of the JCO piston assembly 116 because the JCO piston assembly has engaged the JCO catch piston 112, and the JCO piston assembly begins to contribute to the overall damping performance of the vibration damper 100.

In particular, as illustrated in FIGS. 5 and 6, because the JCO piston assembly 116 has engaged the JCO catch piston 112, hydraulic fluid can no longer flow around the JCO piston assembly and is forced to flow through the JCO piston assembly as the vibration damper 100 is further compressed. As illustrated in FIGS. 5 and 6, however, the JCO valve disc stack-up 118 is not engaged with the valve seat 184, and hydraulic fluid can therefore flow through the JCO piston assembly 116 around the JCO valve disc stack-up 118, that is, without bending or deflecting the JCO valve disc stack-up 118. In this mode, the damping performance of the JCO piston assembly 116 increases as the compression of the vibration damper 100 increases and the damping performance of the JCO piston assembly 116 adds to the damping performance provided by the main piston 112.

FIGS. 7 and 8 illustrate portions of the vibration damper 100 in a compressed configuration relative to that illustrated in FIGS. 5 and 6, in which the JCO piston assembly 116 remains engaged with the JCO catch piston 112, in which the JCO valve disc stack-up 118 has moved toward and engaged with the piston 174 and its valve seat 184, in which the JCO valve piston insert 176 has moved toward the piston 174 such that the volume of the annular void 180 has decreased from its maximum to an intermediate volume, and in which the JCO piston assembly 116 provides an intermediate end-stop resistance. This configuration represents a continuation of the second operational mode of the JCO piston assembly, that is, a partially engaged mode. In this mode, hydraulic fluid cannot flow around the entirety of the JCO piston assembly 116 because the JCO piston assembly is engaged with the JCO catch piston 112, and hydraulic fluid also cannot flow around the JCO valve disc stack-up 118 without deflecting the JCO valve disc stack-up 118. The JCO piston assembly 116 thus continues to contribute to the overall damping performance of the vibration damper 100.

In particular, as illustrated in FIGS. 7 and 8, because the JCO piston assembly 116 is engaged with the JCO catch piston 112, hydraulic fluid cannot flow around the JCO piston assembly and is forced to flow through the JCO piston assembly as the vibration damper 100 is further compressed. Further, because the JCO valve disc stack-up 118 is engaged with the piston 174 and its valve seat 184, hydraulic fluid can no longer flow through the JCO piston assembly 116 around the JCO valve disc stack-up 118, that is, without bending or deflecting the JCO valve disc stack-up 118. Additionally, a preload is applied to the JCO valve disc stack-up 118 at a rate dependent upon a rate at which hydraulic fluid flows out of the annular void 180. In this mode, the damping performance of the JCO piston assembly 116 continues to increase as the compression of the vibration damper 100 increases and the damping performance of the JCO piston assembly 116 adds to the damping performance provided by the main piston 112.

FIGS. 9 and 10 illustrate portions of the vibration damper 100 in a compressed configuration relative to that illustrated in FIGS. 7 and 8, in which the JCO piston assembly 116 remains engaged with the JCO catch piston 112, in which the JCO valve disc stack-up 118 remains engaged with the piston 174 and its valve seat 184, in which the JCO valve disc stack-up 118 has moved further toward the piston 174 and its valve seat 184 until the JCO valve disc stack-up 118 reaches a hard stop against the piston 174, such that the JCO valve disc stack-up 118 now carries a full preload, in which the JCO valve piston insert 176 has moved toward the piston 174 such that the volume of the annular void 180 has decreased to its minimum volume, and in which the JCO piston assembly 116 provides a relatively high end-stop resistance.

This configuration represents a transition from the second operational mode to a third operational mode of the JCO piston assembly, that is, a fully engaged mode. In this mode, hydraulic fluid cannot flow around the entirety of the JCO piston assembly 116 because the JCO piston assembly is engaged with the JCO catch piston 112, and hydraulic fluid also cannot flow around the JCO valve disc stack-up 118 without overcoming its full preload and deflecting the JCO valve disc stack-up 118. Furthermore, in previous modes, forcing hydraulic fluid out of the annular void 180 through the passage 186 may provide some resistance to movement of the piston rod 134 through the damper tube 104, but less than forcing hydraulic fluid through the JCO valve disc stack-up 118. Thus, the resistance provided by the JCO piston assembly in the fully engaged mode is also greater because the volume of the annular void 180 has decreased to its minimum. The JCO piston assembly 116 thus continues to contribute to the overall damping performance of the vibration damper 100.

In particular, as illustrated in FIGS. 9 and 10, because the JCO piston assembly 116 is engaged with the JCO catch piston 112, hydraulic fluid cannot flow around the JCO piston assembly and is forced to flow through the JCO piston assembly as the vibration damper 100 is further compressed. Further, because the JCO valve disc stack-up 118 is engaged with the piston 174 and its valve seat 184, hydraulic fluid cannot flow through the JCO piston assembly 116 around the JCO valve disc stack-up 118, that is, without overcoming its full preload and bending or deflecting the JCO valve disc stack-up 118. Further, because the JCO valve disc stack-up 118 now carries a preload, it takes more force to bend or deform the discs thereof, and more energy is dissipated when hydraulic fluid is forced through the JCO piston assembly 116. In this mode, the damping performance of the JCO piston assembly 116 is at its maximum and the damping performance of the JCO piston assembly 116 adds to the damping performance provided by the main piston 112.

As described herein, the damping performance of the JCO piston assembly 116 increases throughout the process described herein, that is, as the vibration damper compresses toward a bottomed-out configuration, in particular, as the JCO valve disc stack-up 118 moves toward the piston 174, as hydraulic fluid is forced out of the annular void 180, and as the piston 174 moves toward the JCO crimp ring 106. In this sense, the JCO piston assembly 116 described herein provides an operational and/or temporal delay between the various operational modes of the vibration damper 100 and delays the occurrence of a hard stop in the vibration damper 100, in which the piston rod 134 bottoms out.

Furthermore, the rate at which the JCO valve disc stack-up 118 moves toward the piston 174 is dependent upon the rate at which hydraulic fluid is forced out of the annular void 180, which is itself dependent upon the size of the orifice through which hydraulic fluid flows out of the annular void. Thus, for example, the size of the orifice through which hydraulic fluid flows out of the annular void 180 as the vibration damper 100 is compressed can be increased, or the overall volume of the annular void 180 when the vibration damper 100 is in a rest state can be decreased, to increase the rate at which the JCO piston assembly 116 transitions from its first operating mode (disengaged) to its third operating mode (fully engaged).

Similarly, the size of the orifice through which hydraulic fluid flows out of the annular void 180 as the vibration damper 100 is compressed can be decreased, or the overall volume of the annular void 180 when the vibration damper 100 is in a rest state can be increased, to decrease the rate at which the JCO piston assembly 116 transitions from its first operating mode (disengaged) to its third operating mode (fully engaged). In some cases, a rate at which the JCO piston assembly 116 transitions from its first operating mode (disengaged) to its third operating mode (fully engaged) can be controlled by selecting for a specific ratio of the size of the orifice through which hydraulic fluid flows out of the annular void 180 as the vibration damper 100 is compressed to the overall volume of the annular void 180 when the vibration damper 100 is in a rest state. In this sense, these dimensions and geometrical and structural features can be selected to control the degree of the operational and/or temporal delay between the various operational modes of the vibration damper 100 and to control the delay of the occurrence of a hard stop in the vibration damper 100, in which the piston rod 134 bottoms out.

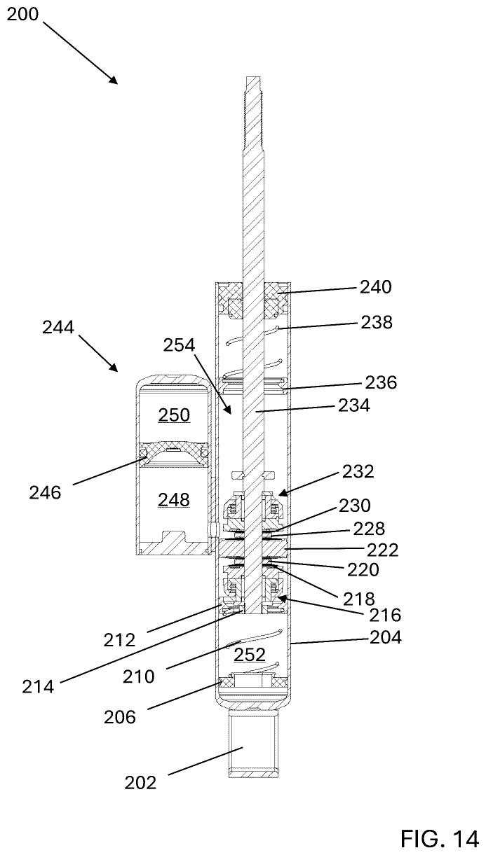

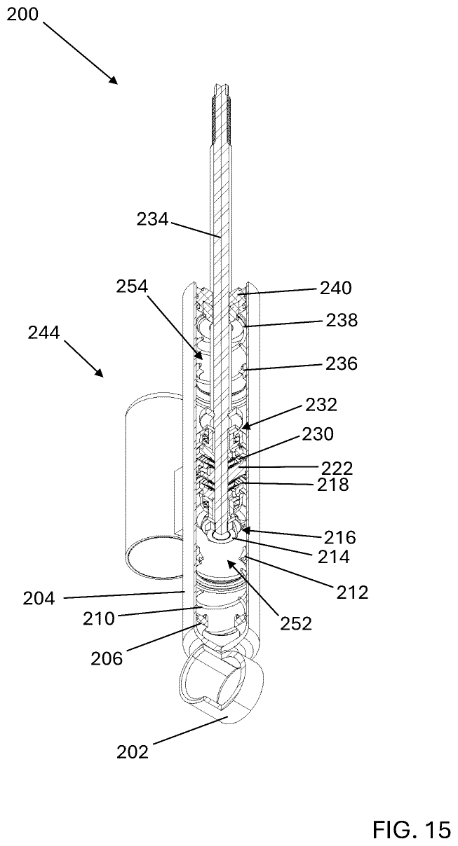

Another example vibration damper 200 is shown in FIGS. 14 and 15, with FIG. 14 showing a cross-sectional view of the vibration damper 200 and FIG. 15 showing a cutaway view of the vibration damper 200. In general, the vibration damper 200 in this example includes an eye ring 202, a damper tube 204, a jounce cutoff (JCO) crimp ring 206 with a spring retention means, a JCO spring 210, a JCO catch piston 212, a piston rod assembly fastener 214, a JCO valve piston assembly 216, a JCO valve disc stack-up 218 of the JCO valve piston assembly 216, a first brake washer 220, a main piston 222 with valve discs, a second brake washer 228, a rebound cutoff (RCO) valve disc stack-up 230, an RCO valve piston assembly 232, a piston rod 234, an RCO catch piston 236, an RCO spring 238, a sealing package 240 with a spring retention means, and a reservoir 244 with a dividing piston 246 that separates the reservoir 244 into a first volume 248 and a second volume 250.

The main piston 222, the JCO valve piston assembly 216, and the RCO valve piston assembly 232, among other components, may be positioned along the piston rod 234 so as to be movable with the piston rod 234 in the damper tube 204 along a longitudinal axis L of the vibration damper 200. The main piston 222 separates an interior of the damper tube 204 into a first working chamber 252 and a second working chamber 254, with the JCO valve piston assembly 216 being disposed in the first working chamber 252 and the RCO valve piston assembly 232 being disposed in the second working chamber 254. The working chambers 252, 254 are fluidly connected to one another by the main piston 222 depending on a direction of movement of the piston rod 234. For this purpose, the main piston 222 includes the valve discs, which govern flow of hydraulic fluid during, respectively, a compression stage and a rebound stage of the vibration damper 200. During operation, the working chambers 252, 254 are filled with hydraulic fluid or damper oil. To increase the damping force in the end regions of the damper tube 204, the JCO valve piston assembly 216 and the RCO valve piston assembly 232 engage, respectively, with the associated catch pistons 212, 236, which will be discussed in more detail further below.

The vibration damper 200 in this example also includes the reservoir 244 in which the dividing piston 246 for separating a damper gas from hydraulic fluid is movably arranged. In other words, the dividing piston 246 separates the first volume 248, which contains hydraulic fluid, from the second volume 250, which contains gas. The first volume 248 is fluidically connected to the first working chamber 252 of the damper tube 204 via a through-opening. During operation, the first volume 248 in the reservoir 244, much like the first and second working chambers 252, 254, is filled with hydraulic fluid. The second volume 250 is filled with gas, which charges, pressurizes, or otherwise biases the dividing piston 246 against the hydraulic fluid.

As can be seen in FIGS. 14 and 15, the main piston 222 is disposed between the JCO valve piston assembly 216 and the RCO valve piston assembly 232 on the piston rod 234. More specifically, the JCO valve piston assembly 216, the JCO valve disc stack-up 218 thereof, the first brake washer 220, the main piston 222, the second brake washer 228, the RCO valve piston assembly 232, and the RCO valve disc stack-up 230 thereof may be securely fastened along the piston rod 234 between the piston rod assembly fastener 214 and a shoulder, for example, of the piston rod 234. Hence, in the case of a compression stage or a rebound stage, the main piston 222, the JCO valve piston assembly 216, and the RCO valve piston assembly 232 move longitudinally with the piston rod 234. In many cases, the JCO valve piston assembly 216 and the RCO valve piston assembly 232 are mirror images of one another. In other cases, though, the JCO valve piston assembly 216 may be different (e.g., in terms of piston shape and/or valve disc stack-up) than the RCO valve piston assembly 232.

A radial gap is provided between the JCO valve piston assembly 216 and an inner wall of the damper tube 204. Likewise, a radial gap is provided between the RCO valve piston assembly 232 and the inner wall of the damper tube 204. Consequently, so long as neither the JCO catch piston 212 nor the RCO catch piston 236 is engaged, hydraulic fluid can flow around the JCO valve piston assembly 216 and around the RCO valve piston assembly 232 during operation of the vibration damper 200.

In some examples, vibration dampers may further include a spacer element that is disposed between a JCO valve piston assembly and a main piston. The spacer element may be pushed onto the piston rod and may, depending on the configuration, prevent the main piston from passing over a through-opening that leads to a reservoir. The spacer element may have a smaller radial extent than the valve piston assemblies. In other words, the spacer element may be configured to be smaller transversely to the longitudinal direction of the vibration damper than the valve piston assemblies. Further, the spacer element can be cylindrical. It should also be understood that the spacer element can have an angular cross section. In other words, the spacer element can also be cuboid.

With continued reference to the example vibration damper 200 shown in FIGS. 14 and 15, the JCO valve piston assembly 216 faces a first end of the damper tube 204. The first end of the damper tube 204 corresponds to an end of the damper tube 204 that faces away from the piston rod 234. The RCO valve piston assembly 232 faces a second end of the damper tube 204. The second end of the damper tube 204 corresponds to an end of the damper tube 204 on the piston rod side. The sealing package 240 is arranged in the damper tube 204 at the second end of the damper tube 204. In some cases, the sealing package 240 may be positively connected to the damper tube 204. The sealing package 240 may be connected to the damper tube 204 by crimping. The piston rod 234 is guided in the sealing package 240 so that the piston rod 234 can move longitudinally through and with respect to the sealing package 240.

In the first working chamber 252 of the damper tube 204, the JCO catch piston 212 is disposed towards the first end 262. The JCO catch piston 212 is movable longitudinally within the damper tube 204, although the JCO spring 210 restores the JCO catch piston 212 to the position shown in FIG. 14 when the JCO catch piston 212 is not engaged. Similarly, in the second working chamber 254 of the damper tube 204, the RCO catch piston 236 is disposed towards the second end 264. The RCO catch piston 236 is movable longitudinally within the damper tube 204, although the RCO spring 238 restores the RCO catch piston 236 to the position shown in FIG. 14 when the RCO catch piston 236 is not engaged. Further, the catch pistons 212, 236 may be annular and may be arranged in a sealing manner with respect to the inner wall 214 of the damper tube 204.

The catch pistons 212, 236 each have a main opening that extends longitudinally and is configured as a longitudinally-extending through opening. Each main opening has a sealing area that is configured to mate with a respective portion of the valve piston assemblies 216, 232. In particular, in the case of end-of-travel damping in compression a JCO piston of the JCO valve piston assembly 216 engages and mates with the sealing area of the JCO catch piston 212 to form a seal. In the case of end-of-travel damping in rebound, an RCO piston of the RCO valve piston assembly 232 engages and mates with the sealing area of the RCO catch piston 236 to form a seal. As can be seen especially in FIG. 14, the JCO piston and the RCO piston each have an outer contour that complements the sealing areas of the main openings.

Also arranged at the first end of the damper tube 204 is the JCO crimp ring 206, which may be positively connected to the damper tube 204 by crimping. The JCO crimp ring 206 and/or the sealing package 240 can also be pressed into the damper tube 204. In other words, the JCO crimp ring 206 and/or the sealing package 240 can be connected to the damper tube 204 in a non-positive manner. The JCO crimp ring 206 and/or the sealing package 240 can additionally or alternatively be integrally connected to the damper tube 206 by welding. In general, it is also conceivable for the JCO crimp ring 206 and/or the sealing package 240 to be connected to the damper tube 204 by still other techniques, including combinations of the connection types mentioned above.

The JCO crimp ring 206 and the sealing package 240 have spring retention means on which the JCO spring 210 and the RCO spring 238 are, respectively, fixedly arranged. The JCO crimp ring 206 and the sealing package 240 are arranged with the spring retention means in the longitudinal direction opposite the respective catch piston 212, 236. The spring retention means serve as an abutment on which the springs 210, 238 are supported. The springs 210, 238 hold the catch pistons 212, 236 in respective longitudinal starting positions when the catch pistons 212, 236 are not engaged. In particular, after end-of-stroke cushioning, the JCO spring 210 guides the JCO catch piston 212 in a compression stage after longitudinal displacement or movement by the JCO valve piston assembly 216 back into the original, longitudinal starting position. Likewise, after end-of-stroke cushioning, the RCO spring 238 guides the RCO catch piston 236 in a rebound stage after longitudinal displacement or movement by the RCO valve piston assembly 232 back into the original, longitudinal starting position. As explained above, the springs 210, 238 serve as return springs. Furthermore, the JCO crimp ring 206 may also include an opening for receiving at least part of the piston rod assembly fastener 214 and the piston rod 234 in a full compression stroke.

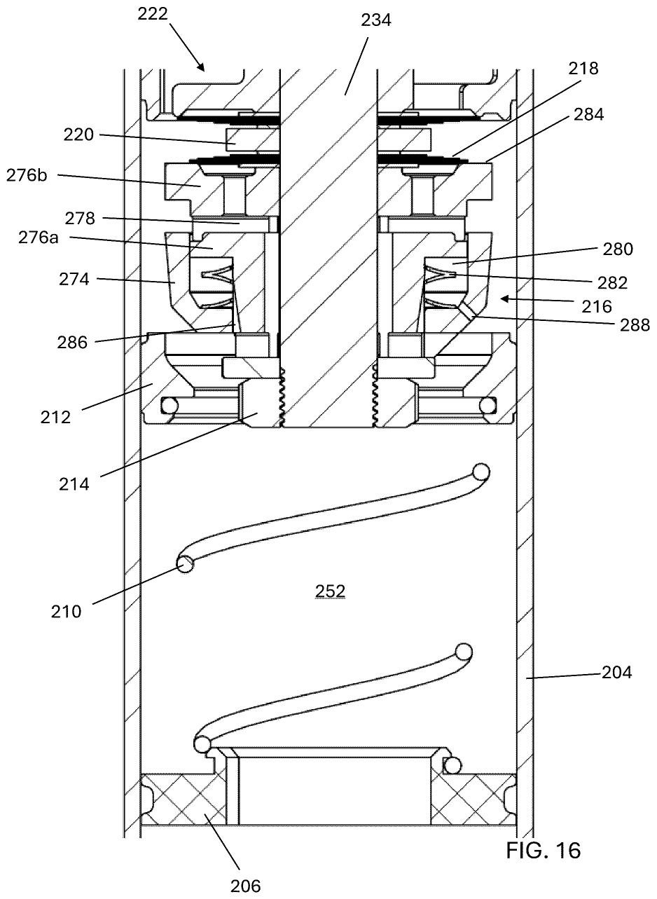

The general operation of the vibration damper 200 and the flow of hydraulic fluid therein will now be explained with reference to FIGS. 16-23, particularly with respect to the relation between the main piston 222 and the valve piston assemblies 216, 232. Although FIGS. 16-23 concern a compression stroke and thus primarily JCO-related components, those having ordinary skill in the art will understand the applicability of this teaching to a rebound stroke and RCO-related components as well.

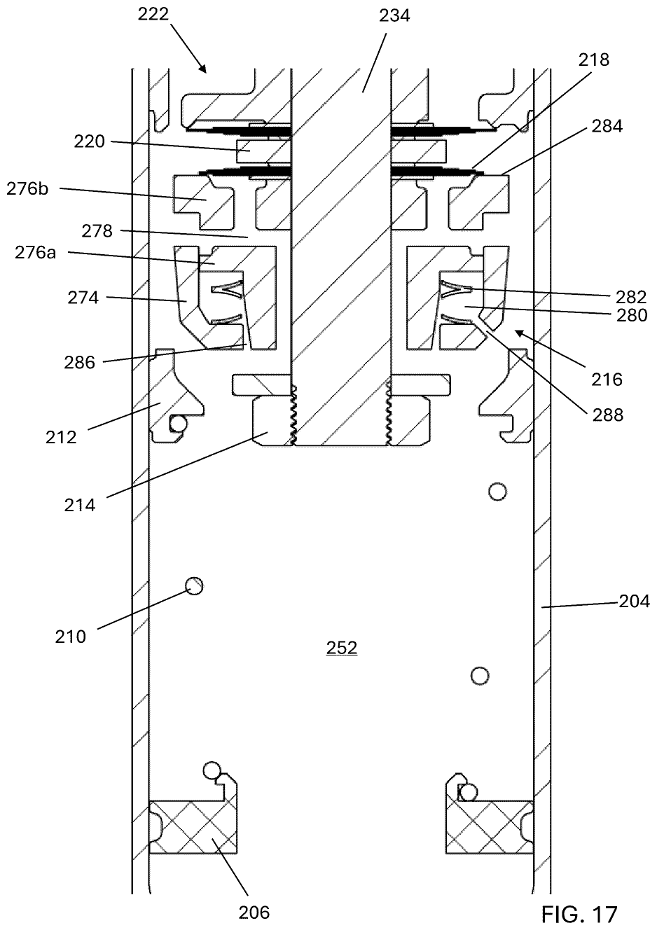

End-of-stroke damping is utilized in compression and in rebound where large displacement of the piston rod 234 occurs. To this end, FIGS. 16 and 17 show the piston rod 234 moving in a compression stroke towards the first end 262 of the damper tube 204. Due to the stroke movement of the main piston 222 and due to the JCO valve piston assembly being spaced apart from the JCO catch piston 212, the hydraulic fluid flows from the first working chamber 252, around the JCO valve piston assembly 216, through the main piston 222, deflecting the valve discs thereof, and into the second working chamber 254. As the hydraulic fluid flows through the main piston 222, such flow is highly controlled such that viscosity, friction, and/or other effects provide resistance to movement of the piston rod 234 relative to the damper tube 204 and convert kinetic energy of the piston rod 234 into heat in the hydraulic fluid, which is then dissipated to the environment through the damper tube 204.

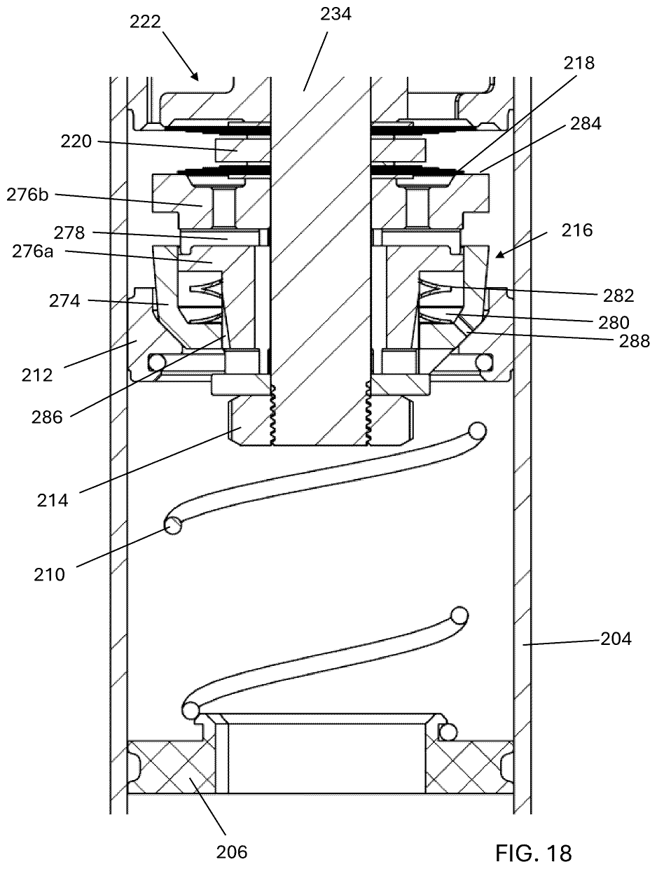

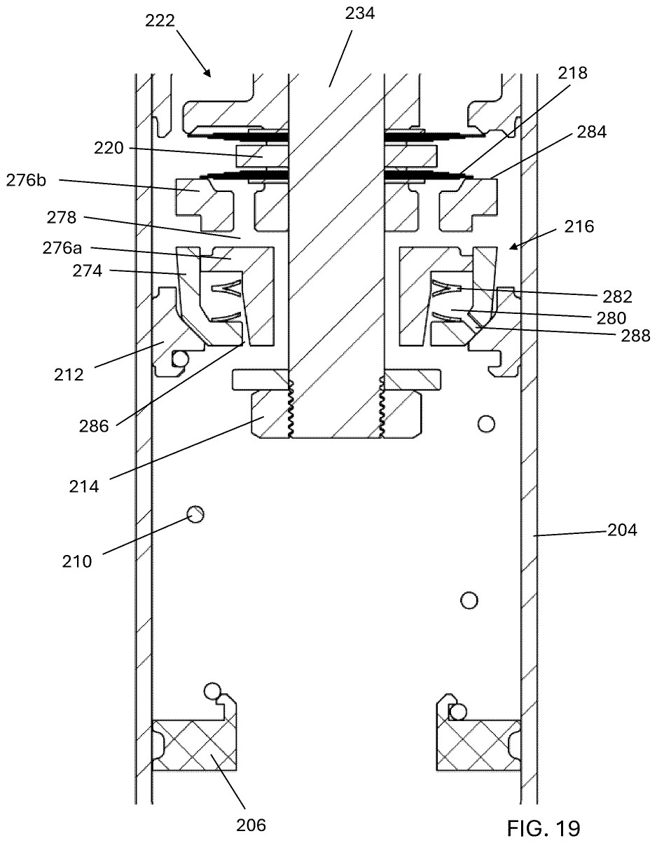

As shown in FIGS. 18 and 19, if the piston rod 234 is driven far enough into the damper tube 204, the JCO valve piston assembly 216, specifically, the JCO piston thereof, engages and mates with the JCO catch piston to form a seal. At this point, hydraulic fluid is sealed in a third working chamber, which in FIGS. 18 and 19 is below the JCO catch piston assembly 216. More details regarding flow through the JCO valve piston assembly 216 will be provided further below, but the hydraulic fluid passes from the third working chamber through the JCO valve piston assembly 216, deflecting the JCO valve disc stack-up 218 thereof, into the first working chamber 252, through the main piston 222, deflecting the valve discs thereof, and into the second working chamber 254.

As the hydraulic fluid flows through the JCO valve piston assembly 216, such flow is highly controlled such that viscosity, friction, and/or other effects provide resistance to movement of the piston rod 234 relative to the damper tube 204 and convert kinetic energy of the piston rod 234 into heat in the hydraulic fluid, which is then dissipated to the environment through the damper tube 204. Because the hydraulic fluid is passing through both the main piston 222 and the JCO valve piston assembly 216, the damping force provided by the deflection of the JCO valve disc stack-up 218 of the JCO valve piston assembly 216 is additive to the damping force provided by the deflection of the valve discs of the main piston 222.

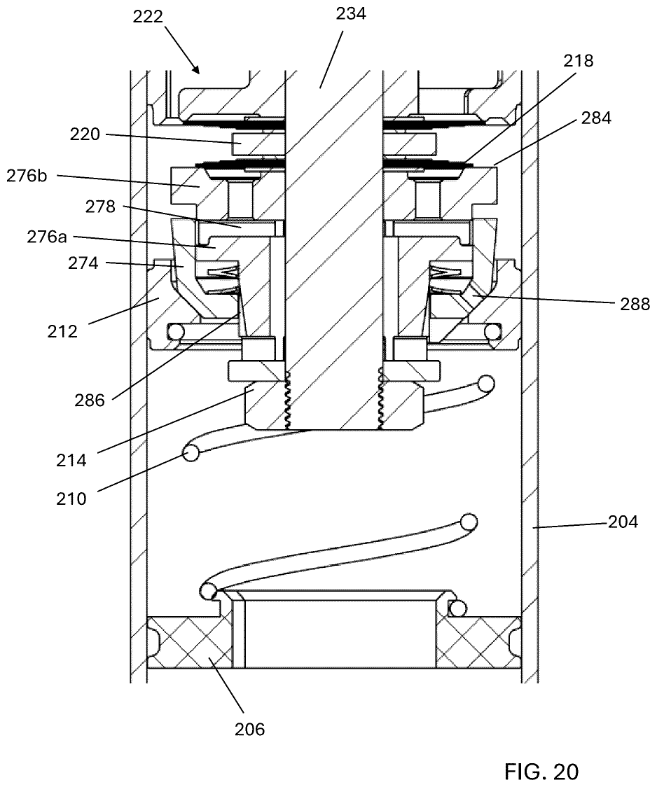

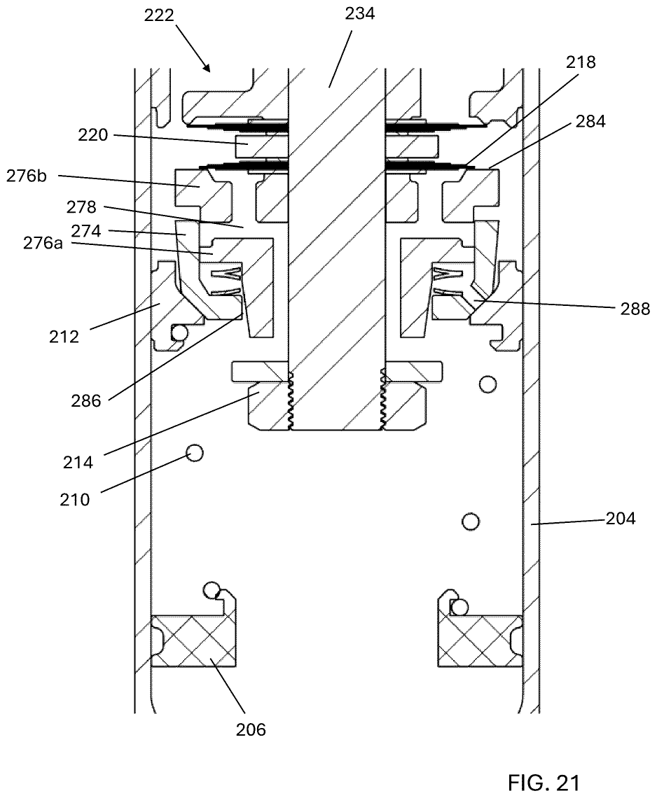

As reflected in FIGS. 20 and 21, as the compression stroke continues, the volume of the third working chamber becomes smaller as the JCO catch piston 212 and the JCO valve piston assembly 216 move closer to the first end of the damper tube 204. The JCO valve disc stack-up 218 deflects even more as the pressure of the hydraulic fluid in the third working chamber builds, thereby providing an increasing amount of damping force.

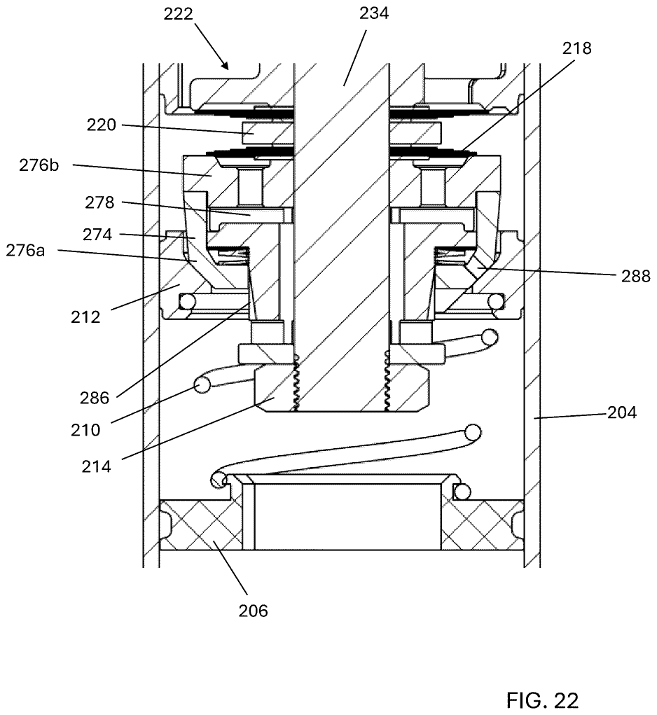

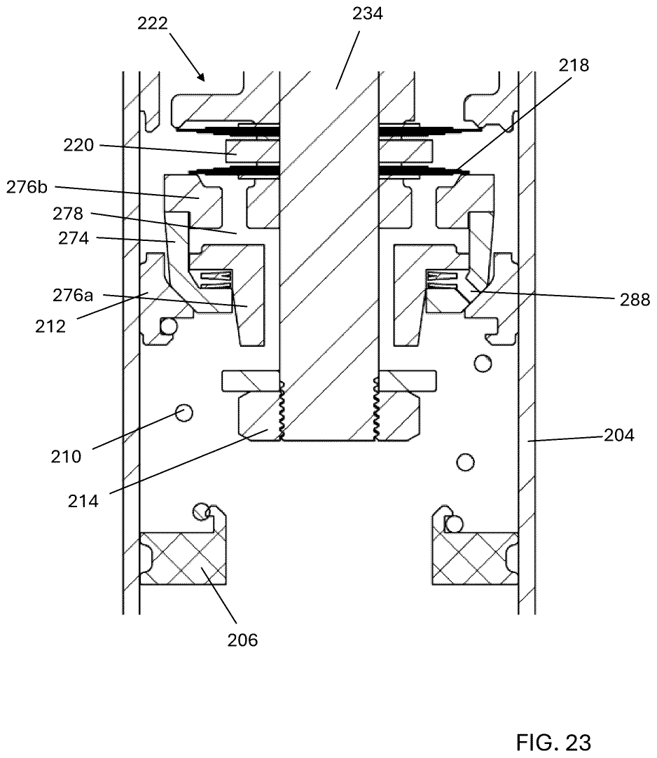

As reflected in FIGS. 22 and 23, as the compression stroke ends when the system bottoms-out, the volume of the third working chamber reaches its minimum.

Immediately following the end of the compression stroke, the JCO valve piston assembly 216 disengages from the JCO catch piston 212 as the piston rod 234, the JCO valve piston assembly 216, the main piston 222, and other components disposed along the piston rod 234 begin moving away from the first end of the damper tube 204. Consequently, hydraulic fluid flows from the second working chamber 254 through the main piston 222, deflecting the valve discs thereof, into the first working chamber 252 and around the JCO valve piston assembly 216. The third working chamber ceases to exist due to the separation of the JCO valve piston assembly 216 from the JCO catch piston 212. The JCO spring 210 then returns the JCO catch piston 212 to its longitudinal starting position.

One having ordinary skill in the art would understand how hydraulic fluid may flow similarly in a rebound stroke involving the RCO valve piston assembly 232 and the RCO catch piston 236.

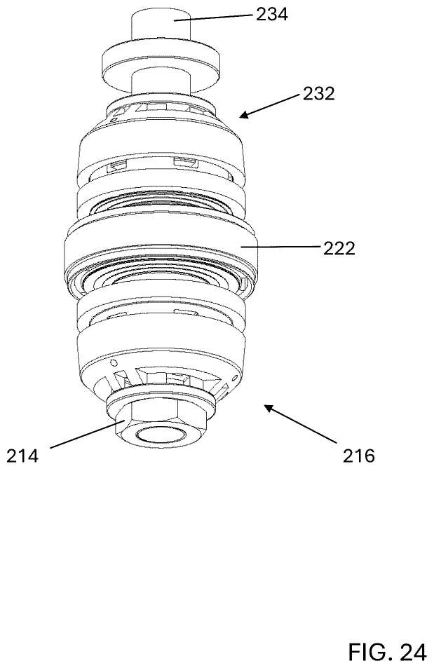

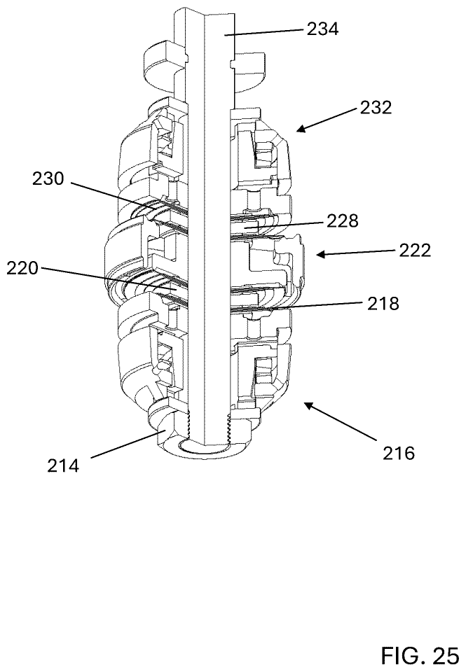

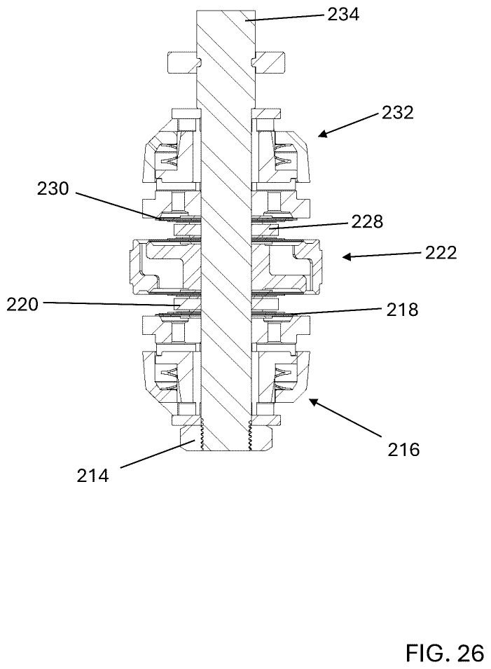

Turning now to FIGS. 24-26, a free or distal end of the piston rod 234 is shown in more detail, with FIG. 24 providing a perspective view, FIG. 25 providing a cutaway view, and FIG. 26 providing a cross-sectional view through the distal end. While more focus may be placed on the JCO valve piston assembly 216 here, those having ordinary skill in the art will appreciate how the teachings may apply with equal force to the RCO valve piston assembly 232.

Building upon the disclosure above, in some examples each valve piston assembly 216, 232 may generally include a respective piston (e.g., valve piston 274 illustrated in FIGS. 16-23), a respective first valve piston insert (e.g., valve piston insert 276a illustrated in FIGS. 16-23), and a respective second valve piston insert (e.g., valve piston insert 276b illustrated in FIGS. 16-23). While the first valve piston insert 267a and the second valve piston insert 276b are described and illustrated herein as two distinct components, they could in alternative embodiments be formed as a single integral, monolithic component. Each valve piston assembly 216, 232 may include passages (e.g., passage 278 illustrated in FIGS. 16-23) that extend longitudinally through the piston and through which hydraulic fluid can flow. For example, as illustrated in FIGS. 16-23, the valve piston assembly 216 includes the passage 278, which extends longitudinally between the piston rod 234 and the first valve piston insert 276a, then radially outward between the first valve piston insert 276a and the second valve piston insert 276b, then longitudinally again through the second valve piston insert 276b to an interface between the valve disc stack-up 218 and a seat of the second valve piston insert 276b.

While the valve piston inserts 276a, 276b, among other components, may be fixed longitudinally along the piston rod 234, the piston 274 may move longitudinally relative to the piston rod 234 and the respective valve piston inserts, as will be described in more detail below. In particular, when the piston 274 is at rest and in a disengaged configuration (that is, when the valve piston assembly 216 is not engaged with or seated against the JCO catch piston 212, as shown, for example, in FIGS. 16 and 17), the radially-extending portion of the passage 278 is open at a radially-outermost side surface of the valve piston assembly 216, forming a bypass opening through which fluid can flow through the valve piston assembly 216 without encountering the JCO valve disc stack-up 218. In contrast, when the piston 274 is in an engaged configuration (that is, when the valve piston assembly 216 is engaged with or seated against the JCO catch piston 212, as shown, for example, in FIGS. 22 and 23), the radially-extending portion of the passage 278 is closed at a radially-outermost side surface of the valve piston assembly 216 by an inner surface of the piston 274, closing the bypass opening such that fluid flowing through the valve piston assembly 216 encounters the JCO valve disc stack-up 218 and is forced to bend the JCO valve disc stack-up 218.

In some examples such as that shown in FIGS. 16-23, the valve piston insert 276a and the piston 274 may be sized and shaped so as to form an annular void 280 longitudinally and radially between the valve piston insert 276a and the piston 274. Wave spring(s) 282 may be inserted in the annular void 280. The wave spring 282 serves to longitudinally separate the piston 274 from the valve piston insert 276, and to return the piston 274 and valve piston insert 276 to their original positions relative to one another, after end-of-stroke damping events. The annular void 280 provides a reservoir of hydraulic fluid that can be physically distinct from, and separated and isolated from, the first working chamber 252 except that it is hydraulically coupled to the first working chamber 252 by a passage or passages 286.

The piston 274 may have a valve seat 284 that extends annularly around the piston rod 234 and forms a seal with the respective valve disc stack-up 218. The valve seat 284 may be chamfered or radiused. As one having ordinary skill in the art will appreciate, such chamfers or radiuses may be configured to accommodate preload of the valve disc stack-ups 218, 230; help form a better seal with the valve disc stack-ups 218, 230; facilitate better control over the flow of hydraulic fluid; and enable smooth deformation of the valve disc stack-ups 218, 230 during end-of-stroke damping.

FIGS. 16 and 17 illustrate portions of the vibration damper 200 in a compressed configuration relative to that illustrated in FIGS. 14 and 15, but before the JCO piston assembly 216 engages the JCO catch piston 212. This configuration represents a first operational mode of the JCO piston assembly, that is, a disengaged mode. In this mode, hydraulic fluid can flow around the entirety of the JCO piston assembly 216, so the JCO piston assembly does not contribute in a significant way to the overall damping performance of the vibration damper 200. In this mode, the overall damping performance or the entirety of the damping performance of the vibration damper 200 is provided by the main piston 222.

FIGS. 18 and 19 illustrate portions of the vibration damper 200 in a compressed configuration relative to that illustrated in FIGS. 16 and 17, and in which the JCO piston assembly 216 initially engages the JCO catch piston 212, in which the volume of the annular void 280 is at its maximum, and in which the JCO piston assembly 216 provides a relatively low end-stop resistance. This configuration represents a transition from the first operational mode to a second operational mode of the JCO piston assembly 216, that is, a partially engaged mode. In this configuration, hydraulic fluid can no longer flow around the entirety of the JCO piston assembly 216 because the JCO piston assembly has engaged the JCO catch piston 212, and the JCO piston assembly begins to contribute to the overall damping performance of the vibration damper 200.

In particular, as illustrated in FIGS. 18 and 19, because the JCO piston assembly 216 has engaged the JCO catch piston 212, hydraulic fluid can no longer flow around the JCO piston assembly and is forced to flow through the JCO piston assembly as the vibration damper 200 is further compressed. As illustrated in FIGS. 18 and 19, however, the JCO piston assembly 216 includes a flow path that allows hydraulic fluid to flow through the JCO piston assembly 216, bypassing the JCO valve disc stack-up 218, and hydraulic fluid can therefore flow through the JCO piston assembly 216 around the JCO valve disc stack-up 218, that is, without significantly bending or deflecting the JCO valve disc stack-up 218. In this mode, the damping performance of the JCO piston assembly 216 adds to the damping performance provided by the main piston 212.

FIGS. 20 and 21 illustrate portions of the vibration damper 200 in a compressed configuration relative to that illustrated in FIGS. 18 and 19, in which the JCO piston assembly 216 remains engaged with the JCO catch piston 212, in which the JCO valve piston inserts 276a and 276b have moved toward the piston 274 such that the volume of the annular void 280 has decreased from its maximum to an intermediate volume and such that the piston 274 covers the bypass opening of the passage 278, and in which the JCO piston assembly 216 provides an intermediate end-stop resistance. This configuration represents a continuation of the second operational mode of the JCO piston assembly, that is, a partially engaged mode. In this mode, hydraulic fluid cannot flow around the entirety of the JCO piston assembly 216 because the JCO piston assembly is engaged with the JCO catch piston 212, and hydraulic fluid also cannot flow around the JCO valve disc stack-up 218 without deflecting the JCO valve disc stack-up 218. The JCO piston assembly 216 thus continues to contribute to the overall damping performance of the vibration damper 200.

In particular, as illustrated in FIGS. 20 and 21, because the JCO piston assembly 216 is engaged with the JCO catch piston 212, hydraulic fluid cannot flow around the JCO piston assembly and is forced to flow through the JCO piston assembly as the vibration damper 200 is further compressed. Further, because the piston 274 covers the bypass opening of the passage 286, hydraulic fluid can no longer flow through the JCO piston assembly 216 around the JCO valve disc stack-up 218, that is, without bending or deflecting the JCO valve disc stack-up 218. In this mode, the damping performance of the JCO piston assembly 216 continues to increase as the compression of the vibration damper 200 increases and the damping performance of the JCO piston assembly 216 adds to the damping performance provided by the main piston 212.

In this mode of operation, damping performance (e.g., in terms of a damping force provided by the vibration damper 200), which is dependent upon a rate at which hydraulic fluid is forced to flow past the JCO valve disc stack-up 218 (and thus the rate at which kinetic energy of the piston rod 234 is converted to heat by viscosity, friction, and/or other effects), is dependent upon both the rate at which the piston rod 234 travels longitudinally with respect to the damper tube 204, as well as the rate at which the piston 274 and catch piston 212 travel longitudinally with respect to the piston rod 234. In particular, the rate at which hydraulic fluid is forced to flow past the JCO valve disc stack-up 218 is equal to the rate at which the piston rod 234 travels longitudinally with respect to the damper tube 204 multiplied by its total baseline area of effect (the interior cross sectional area of the damper tube 204) minus the rate at which the piston 274 and catch piston 212 travel longitudinally with respect to the piston rod 234 multiplied by their area of effect, (an annular shape defined as the circular interior cross sectional area of the damper tube 204 minus a circular area having a radius corresponding to a radius of a radially-innermost surface of the piston 274). Thus, as the piston 274 moves more slowly relative to the piston rod 234, hydraulic fluid is forced to flow past the JCO valve disc stack-up 218 more quickly, thereby increasing the damping force provided by the vibration damper 200.

FIGS. 22 and 23 illustrate portions of the vibration damper 200 in a compressed configuration relative to that illustrated in FIGS. 20 and 21, in which the JCO piston assembly 216 remains engaged with the JCO catch piston 212, in which the JCO valve disc stack-up 218 remains engaged with the piston 274 and its valve seat 284, in which the piston 274 continues to cover the bypass opening of the passage 278, in which the JCO valve piston insert 276a has moved toward the piston 274 such that the volume of the annular void 280 has decreased to its minimum volume, and in which the JCO piston assembly 216 provides a relatively high end-stop resistance. This configuration represents a transition from the second operational mode to a third operational mode of the JCO piston assembly, that is, a fully engaged mode. In this mode, hydraulic fluid cannot flow around the entirety of the JCO piston assembly 216 because the JCO piston assembly is engaged with the JCO catch piston 212, and hydraulic fluid also cannot flow around the JCO valve disc stack-up 218 without deflecting the JCO valve disc stack-up 218. Furthermore, in previous modes, forcing hydraulic fluid out of the annular void 280 through the passage 286 may provide some resistance to movement of the piston rod 234 through the damper tube 204, but less than forcing hydraulic fluid through the JCO valve disc stack-up 218. Thus, the resistance provided by the JCO piston assembly in the fully engaged mode is also greater because the volume of the annular void 280 has decreased to its minimum. The JCO piston assembly 216 thus continues to contribute to the overall damping performance of the vibration damper 200.

In particular, as illustrated in FIGS. 22 and 23, because the JCO piston assembly 216 is engaged with the JCO catch piston 212, hydraulic fluid cannot flow around the JCO piston assembly and is forced to flow through the JCO piston assembly as the vibration damper 200 is further compressed. Further, because the JCO valve disc stack-up 218 is engaged with the piston 274 and its valve seat 284, hydraulic fluid cannot flow through the JCO piston assembly 216 around the JCO valve disc stack-up 218, that is, without bending or deflecting the JCO valve disc stack-up 218. In this mode, the damping performance of the JCO piston assembly 216 is at its maximum and the damping performance of the JCO piston assembly 216 adds to the damping performance provided by the main piston 212.

As described herein, the damping performance of the JCO piston assembly 216 increases throughout the process described herein, that is, as the vibration damper compresses toward a bottomed-out configuration, in particular, as the valve piston insert 276a moves toward the valve piston 274 to close the bypass passage, as hydraulic fluid is forced out of the annular void 280, and as the piston 274 moves toward the JCO crimp ring 206. In this sense, the JCO piston assembly 216 described herein provides an operational and/or temporal delay between the various operational modes of the vibration damper 200 and delays the occurrence of a hard stop in the vibration damper 200, in which the piston rod 234 bottoms out.

Furthermore, the rate at which the valve piston insert 276a moves toward the valve piston 274 to close the bypass passage and the rate at which the piston 274 moves toward the JCO crimp ring 206 are dependent upon the rate at which hydraulic fluid is forced out of the annular void 280, which is itself dependent upon the size of the orifice through which hydraulic fluid flows out of the annular void 280 (e.g., a minimum size of the passage 286). Thus, for example, the size of the orifice through which hydraulic fluid flows out of the annular void 280 as the vibration damper 200 is compressed can be increased, or the overall volume of the annular void 280 when the vibration damper 200 is in a rest state can be decreased, to increase the rate at which the JCO piston assembly 216 transitions from its first operating mode (disengaged) to its third operating mode (fully engaged).

Similarly, the size of the orifice through which hydraulic fluid flows out of the annular void 280 as the vibration damper 200 is compressed can be decreased, or the overall volume of the annular void 280 when the vibration damper 200 is in a rest state can be increased, to decrease the rate at which the JCO piston assembly 216 transitions from its first operating mode (disengaged) to its third operating mode (fully engaged). In some cases, a rate at which the JCO piston assembly 216 transitions from its first operating mode (disengaged) to its third operating mode (fully engaged) can be controlled by selecting for a specific ratio of the size of the orifice through which hydraulic fluid flows out of the annular void 280 as the vibration damper 200 is compressed to the overall volume of the annular void 280 when the vibration damper 200 is in a rest state. In this sense, these dimensions and geometrical and structural features can be selected to control the degree of the operational and/or temporal delay between the various operational modes of the vibration damper 200 and to control the delay of the occurrence of a hard stop in the vibration damper 200, in which the piston rod 234 bottoms out.

In some cases, such as in the case of the vibration damper 200, the size of the orifice through which hydraulic fluid flows out of the annular void 280 (e.g., a minimum size of the passage 286) can vary or change as the piston rod 234 travels through the damper tube 204. For example, as illustrated in FIGS. 16-23, the passage 286 extends generally longitudinally between a radially outer surface of the first valve piston insert 276a and a radially inner surface of the valve piston 274. The inner surface of the valve piston 274 generally extends linearly and longitudinally, while the outer surface of the valve piston insert 276a generally extends along a curved profile such that it is closest to the inner surface at a location proximate the annular void 280 and further from the inner surface at a location distal to the annular void 280. Thus, as the valve piston insert 276a moves toward the valve piston 274, the size of the orifice through which hydraulic fluid flows out of the annular void 280 (e.g., a minimum size of the passage 286) decreases and resistance to flow of hydraulic fluid out of the annular void 280 increases and the speed at which hydraulic fluid flows out of the annular void slows. As described herein, providing the outer surface of the valve piston insert 276a with a curved profile is one way to achieve these effects, but other features could be used to achieve the same or similar effects, including tapered grooves, grooves of different lengths, etc.

In contrast to the operation of vibration damper 100, in vibration damper 200, the JCO valve disc stack-up 218 does not move relative to the valve seat 284. Thus, preload applied to the JCO valve disc stack-up 218 may be constant, and/or may be zero.

As illustrated in FIGS. 16-23, the valve piston 274 includes a relief conduit 288 that extends from an inner surface thereof at an interior of the annular void 280, to an outer surface thereof. When the JCO valve piston assembly 216 engages the JCO catch piston 212, the JCO catch piston 212 seals the relief conduit 288 shut at the outer surface of the valve piston 274, such that hydraulic fluid cannot escape or enter the annular void 280 through the relief conduit 288. When a jounce phase of operation ends, however, and the JCO valve piston assembly 216 disengages from the JCO catch piston 212, the JCO catch piston 212 no longer seals the relief conduit 288 shut at the outer surface of the valve piston 274, such that hydraulic fluid can enter the annular void 280 through the relief conduit 288 so that the annular void 280 can more readily expand and be refilled by hydraulic fluid.

The embodiments described herein are configured to provide, among other things, a progressive force output by slowly closing off a bypass around a valve disc stack-up. The rate of bypass closure is slowed by a pocket of trapped fluid that acts as a hydraulic cushion before full engagement. The trapped fluid can also be used to control movement of the piston assembly after the bypass is closed, reducing the rate at which hydraulic oil moves through the valving, which in turn smooths the overall force output of the vibration damper.

In the embodiments described herein, tight tolerances between mating components can serve as seals. In alternate configurations such seals may be formed with O-rings or wear bands.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise herein. It will also be understood that the description, including disclosed examples and drawings, is intended for purposes of illustration only and is not intended to limit the scope of the present disclosure, its application or uses. Thus, variations that do not depart from the gist of the present disclosure are intended to be within the scope of the present disclosure.

What is claimed is:

1. An end-stop control valve, comprising:
a piston assembly configured to move longitudinally within a damper tube;
a valve disc stack-up; and
a catch piston configured to engage the piston assembly during an end-of-stroke damping event, the catch piston configured to be disposed on an inner wall of the damper tube in a longitudinally movable manner;
wherein a radially outermost portion of the piston assembly is configured to be spaced radially apart from the inner wall of the damper tube such that hydraulic fluid can flow between the piston assembly and the inner wall of the damper tube outside of the end-of-stroke damping event and when the piston assembly is not engaged with the catch piston;
wherein the piston assembly is configured such that, when a contact surface of the piston assembly contacts a contact surface of the catch piston such that hydraulic fluid cannot flow around the piston assembly during the end-of-stroke damping event, the end-stop control valve is configured to operate, first, such that hydraulic fluid flows through the piston assembly and bypasses the valve disc stack-up, and second, such that hydraulic fluid flows through the piston assembly and deflects the valve disc stack-up.

2. The end-stop control valve of claim 1 wherein the piston assembly is configured such that a size of an aperture through which hydraulic fluid bypasses the valve disc stack-up decreases during the end-of-stroke damping event such that the piston assembly progressively transitions from hydraulic fluid bypassing the valve disc stack-up to hydraulic fluid deflecting the valve disc stack-up.

3. The end-stop control valve of claim 2 wherein the piston assembly includes an annular void and the rate at which the aperture through which hydraulic fluid bypasses the valve disc stack-up decreases during the end-of-stroke damping event and the rate at which the piston assembly progressively transitions from hydraulic fluid bypassing the valve disc stack-up to hydraulic fluid deflecting the valve disc stack-up are dependent upon a rate at which hydraulic fluid escapes from the annular void.

4. The end-stop control valve of claim 3 wherein the rate at which hydraulic fluid escapes from the annular void depends upon a size of an orifice through which hydraulic fluid can flow out of the annular void.

5. The end-stop control valve of claim 4 wherein the piston assembly includes a piston insert that is fixed relative to the valve disc stack-up and a piston configured to travel longitudinally relative to the valve disc stack-up, wherein the orifice is formed between a linear inner surface of the piston and an outer surface of the piston insert that is curved such that, as the piston moves toward the piston insert, the size of the orifice decreases, resistance to flow of hydraulic fluid out of the annular void increases, and the speed at which hydraulic fluid flows out of the annular void slows.

6. The end-stop control valve of claim 1 wherein the piston assembly is configured such that, as hydraulic fluid flows through the piston assembly, a preload is applied to the valve disc stack-up at a rate dependent upon a rate at which hydraulic fluid flows out of an annular void within the piston assembly.

7. The end-stop control valve of claim 1 wherein the piston assembly is configured such that no preload is applied to the valve disc stack-up.

8. The end-stop control valve of claim 1 wherein the piston assembly includes a piston insert that is fixed relative to the valve disc stack-up and a piston configured to travel longitudinally relative to the valve disc stack-up.

9. The end-stop control valve of claim 8 wherein the piston assembly includes a passage by which hydraulic fluid can flow through the piston assembly, wherein the passage extends radially outward and longitudinally through the piston insert.

10. The end-stop control valve of claim 9 wherein the passage extends longitudinally to an interface between the valve disc stack-up and a seat of the piston insert.

11. The end-stop control valve of claim 9 wherein, when the piston assembly is not engaged with the catch piston, the radially-extending portion of the passage is open at a radially-outermost side surface of the piston assembly, forming a bypass opening through which hydraulic fluid can flow through the piston assembly without encountering the valve disc stack-up.

12. The end-stop control valve of claim 11 wherein, during the end-of-stroke damping event, the piston is configured to travel longitudinally relative to the piston insert such that the radially-extending portion of the passage is closed at the radially-outermost side surface of the piston assembly by an inner surface of the piston, closing the bypass opening such that hydraulic fluid cannot flow through the piston assembly without encountering the valve disc stack-up.

13. The end-stop control valve of claim 8 wherein the piston insert is a first piston insert, the piston assembly includes a second piston insert, and the piston assembly includes a passage by which hydraulic fluid can flow through the piston assembly, wherein the passage extends longitudinally between a piston rod and the first piston insert, radially outward between the first piston insert and the second piston insert, and longitudinally through the second piston insert.

14. A vibration damper comprising:
a damper tube that extends along a longitudinal axis and includes an inner wall;
a piston rod that extends into the damper tube and is configured to move longitudinally within the damper tube;
a main piston secured on the piston rod that separates the damper tube into a first working chamber and a second working chamber, wherein the main piston includes a first valve disc stack-up;
an end-stop control valve disposed on a longitudinal side of the main piston, the end-stop control valve including:
a second piston configured to move longitudinally within the damper tube;
a second valve disc stack-up; and
a catch piston configured to engage the second piston during an end-of-stroke damping event, the catch piston disposed on the inner wall of the damper tube in a longitudinally movable manner;
wherein a radially outermost portion of the second piston is spaced radially apart from the inner wall of the damper tube such that hydraulic fluid can flow between the second piston and the inner wall of the damper tube outside of the end-of-stroke damping event and when the second piston is not engaged with the catch piston;
wherein the second piston is configured such that, when a contact surface of the second piston contacts a contact surface of the catch piston such that hydraulic fluid cannot flow around the second piston during the end-of-stroke damping event, the end-stop control valve is configured to operate, first, such that hydraulic fluid flows through the second piston and bypasses the second valve disc stack-up, and second, such that hydraulic fluid flows through the second piston and deflects the second valve disc stack-up.

15. The vibration damper of claim 14 wherein the end-stop control valve is a jounce cutoff end-stop control valve.

16. The vibration damper of claim 14 wherein the end-stop control valve is a rebound cutoff end-stop control valve.

17. The vibration damper of claim 14 wherein the end-stop control valve is a first end-stop control valve, the catch piston is a first catch piston, and the vibration damper further comprises a second end-stop control valve, the second end-stop control valve including:
a third piston configured to move longitudinally within the damper tube;
a third valve disc stack-up; and
a second catch piston configured to engage the third piston during an end-of-stroke damping event, the second catch piston disposed on the inner wall of the damper tube in a longitudinally movable manner;
wherein a radially outermost portion of the third piston is spaced radially apart from the inner wall of the damper tube such that hydraulic fluid can flow between the third piston and the inner wall of the damper tube outside of the end-of-stroke damping event and when the third piston is not engaged with the second catch piston;
wherein the third piston is configured such that, when a contact surface of the third piston contacts a contact surface of the second catch piston such that hydraulic fluid cannot flow around the third piston during the end-of-stroke damping event, the second end-stop control valve is configured to operate, first, such that hydraulic fluid flows through the third piston and bypasses the third valve disc stack-up, and second, such that hydraulic fluid flows through the third piston and deflects the third valve disc stack-up.
